(19) United States
(12) Patent Application Publication
(10) Pub. No.: US 2023/0396355 A1
(43) Pub. Date: Dec. 7, 2023

(54) WIRELESS COMMUNICATIONS BASED ON RATELESS CODES AND LAYERED MODULATION

(71) Applicant: QUALCOMM INCORPORATED, San Diego, CA (US)

(72) Inventors: Kangqi LIU, San Diego, CA (US); Liangming WU, Beijing (CN); Changlong XU, Beijing (CN); Jian LI, Shanghai (CN); Hao XU, Beijing (CN); Ruiming ZHENG, Beijing (CN)

(21) Appl. No.: 18/249,922

(22) PCT Filed: Dec. 14, 2020
(86) PCT No.: PCT/CN2020/136029

§ 371 Date: Apr. 20, 2023

(51) Int. Cl. H04L 1/00

(52) U.S. Cl. CPC H04L 1/0003; H04L 1/0061; H04L 1/0009

(57) ABSTRACT

Methods, systems, and devices for wireless communications are described. A rateless code may be used to generate n encoded packets based on a set of source packets. A modulation technique may be used to generate first symbol packets from the encoded packets. And a layered modulation technique may be used to generate coded symbol packets from the first symbol packets. The layered modulation technique may include generating a coded symbol packet from a group of first symbol packets. Different weights may be applied to the different first symbol packets included in the group of first symbol packets before the first symbol packets in the group are combined together. A receiving device may demodulate the transmitted coded symbol packets to reconstruct the group of first symbol packets, use the reconstructed group of first symbol packets to recover the encoded packets, and use the encoded packets to reconstruct the source packets.

### CROSS REFERENCE

The present application is a 371 national stage filing of International PCT Application No. PCT/CN2020/136029 by LIU et al. entitled “WIRELESS COMMUNICATIONS BASED ON RATELESS CODES AND LAYERED MODULATION,” filed Dec. 14, 2020, which is assigned to the assignee hereof, and which is expressly incorporated by reference in its entirety herein.

### FIELD OF TECHNOLOGY

The following relates to wireless communications, including wireless communications based on rateless codes and layered modulation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

Communication devices may encode and modulate information for another communication device prior to transmitting the information over a wireless channel. In some examples, a communication device selects an encoding technique and a modulation technique based on information about the wireless channel reported by another communication device. A communication device that receives a transmission may demodulate and decode the transmission using a demodulation and decoding technique that is complementary to the encoding and modulation technique used by the communication device that transmits the transmission.

### SUMMARY

The described techniques relate to improved methods, systems, devices, and apparatuses that support wireless communications based on rateless codes and layered modulation. A rateless code may be used to generate encoded packets based on a set of source packets. A modulation technique may be used to generate first symbol packets from the encoded packets. And a layered modulation technique may be used to generate coded symbol packets from the first symbol packets.

In some cases, the layered modulation technique may include generating a coded symbol packet from a group of first symbol packets. Different weights may be applied to the different first symbol packets included in the group of first symbol packets before the first symbol packets in the group are combined together. A receiving device may demodulate the transmitted coded symbol packets to reconstruct the group of first symbol packets, use the reconstructed group of first symbol packets to recover the encoded packets, and use the encoded packets to reconstruct the source packets.

A method for wireless communication at a transmitting device is described. The method may include generating, using a rateless code, encoded packets based on source packets including information for a receiving device, generating sets of binary symbols based on the encoded packets, selecting groups of sets of binary symbols, each of the groups including one or more of the sets of binary symbols, generating a respective set of coded symbols for each of the groups, the respective set of coded symbols for a group based on the one or more sets of binary symbols included in the group, and transmitting, to the receiving device, a set of multiple sets of coded symbols based on the generated respective sets of coded symbols.

An apparatus for wireless communication at a transmitting device is described. The apparatus may include a processor, memory in electronic communication with the processor, and instructions stored in the memory. The instructions may be executable by the processor to cause the apparatus to generate, used a rateless code, encoded packets based on source packets including information for a receiving device, generate sets of binary symbols based on the encoded packets, select groups of sets of binary symbols, each of the groups including one or more of the sets of binary symbols, generate a respective set of coded symbols for each of the groups, the respective set of coded symbols for a group based on the one or more sets of binary symbols included in the group, and transmit, to the receiving device, a set of multiple sets of coded symbols based on the generated respective sets of coded symbols.

Another apparatus for wireless communication at a transmitting device is described. The apparatus may include means for generating, using a rateless code, encoded packets based on source packets including information for a receiving device, means for generating sets of binary symbols based on the encoded packets, means for selecting groups of sets of binary symbols, each of the groups including one or more of the sets of binary symbols, means for generating a respective set of coded symbols for each of the groups, the respective set of coded symbols for a group based on the one or more sets of binary symbols included in the group, and means for transmitting, to the receiving device, multiple sets of coded symbols based on generating the respective sets of coded symbols.

A non-transitory computer-readable medium storing code for wireless communication at a transmitting device is described. The code may include instructions executable by a processor to generate, used a rateless code, encoded packets based on source packets including information for a receiving device, generate sets of binary symbols based on the encoded packets, select groups of sets of binary symbols, each of the groups including one or more of the sets of binary symbols, generate a respective set of coded symbols for each of the groups, the respective set of coded symbols for a group based on the one or more sets of binary symbols included in the group, and transmit, to the receiving device, a set of multiple sets of coded symbols based on the generated respective sets of coded symbols.

Some examples of the method, apparatuses, and non-transitory computer-readable medium described herein may further include operations, features, means, or instructions for generating the source packets based on the information for the receiving device, where each of the source packets and each of the encoded packets includes a first quantity of bits.

Some examples of the method, apparatuses, and non-transitory computer-readable medium described herein may further include operations, features, means, or instructions for adding, to each of the encoded packets, an error-detecting code to obtain second encoded packets, each of the second encoded packets including a second quantity of bits greater than the first quantity of bits.

In some examples of the method, apparatuses, and non-transitory computer-readable medium described herein, operations, features, means, or instructions for generating the sets of binary symbols may include operations, features, means, or instructions for generating a respective set of binary symbols for each of the second encoded packets, the respective set of binary symbols for a second encoded packet based on modulating each bit included in the second encoded packet in accordance with a first modulation order.

In some examples of the method, apparatuses, and non-transitory computer-readable medium described herein, operations, features, means, or instructions for generating the respective set of coded symbols for a group of sets of binary symbols may include operations, features, means, or instructions for mapping the one or more sets of binary symbols included in the group to coded symbols included in the respective set of coded symbols, the mapping based on a layered modulation constellation.

In some examples of the method, apparatuses, and non-transitory computer-readable medium described herein, operations, features, means, or instructions for generating the respective set of coded symbols for a group of sets of binary symbols may include operations, features, means, or instructions for identifying multiple sets of binary symbols included in the group of sets of binary symbols and combining, across the multiple sets of binary symbols included in the group, corresponding binary symbols to obtain the respective set of coded symbols.

In some examples of the method, apparatuses, and non-transitory computer-readable medium described herein, each of the multiple sets of binary symbols may be associated with a common set of binary symbol positions, and operations, features, means, or instructions for combining the corresponding binary symbols may include operations, features, means, or instructions for identifying, for each set of binary symbols included in the multiple sets of binary symbols, a respective value for scaling the binary symbols included in the set of binary symbols, multiplying, for each set of binary symbols included in the multiple sets of binary symbols, the binary symbols included in the set of binary symbols by the respective value for the set of binary symbols to obtain multiple sets of scaled binary symbols, and summing, across the multiple sets of scaled binary symbols, the scaled binary symbols having a common binary symbol position.

In some examples of the method, apparatuses, and non-transitory computer-readable medium described herein, each of the multiple sets of binary symbols may have a respective position within the multiple sets of binary symbols, and the respective values for the multiple sets of binary symbols change across the multiple sets of binary symbols in a descending order.

In some examples of the method, apparatuses, and non-transitory computer-readable medium described herein, each respective position within the multiple sets of binary symbols corresponds to a respective index, and the respective value for scaling a set of binary symbols having an intermediate position within the multiple sets of binary symbols may be less than or equal to a first quantity, the first quantity based on multiplying a first quotient by the respective value for scaling a first set of binary symbols, the first set of binary symbols having a first position that proceeds the intermediate position, and the first quotient obtained by dividing two raised to the index of the first position by two raised to the index of the intermediary position, and greater than or equal to a second quantity, the second quantity based on multiplying a second quotient by the respective value for scaling a second set of binary symbols, the second set of binary symbols having a second position that may be subsequent to the intermediate position, and the second quotient obtained by dividing two raised to the index of the second position by two raised to the index of the intermediary position.

In some examples of the method, apparatuses, and non-transitory computer-readable medium described herein, a result of summing the square of each of the respective values may be less than or equal to one.

Some examples of the method, apparatuses, and non-transitory computer-readable medium described herein may further include operations, features, means, or instructions for estimating a channel between the transmitting device and the receiving device, where a quantity of sets of binary symbols included in at least one of the groups of sets of binary symbols may be selected based on a quality of the channel.

Some examples of the method, apparatuses, and non-transitory computer-readable medium described herein may further include operations, features, means, or instructions for transmitting, to the receiving device, an indication of a quantity of sets of binary symbols included in at least one of the groups of sets of binary symbols.

In some examples of the method, apparatuses, and non-transitory computer-readable medium described herein, the groups of sets of binary symbols may be disjoint.

Some examples of the method, apparatuses, and non-transitory computer-readable medium described herein may further include operations, features, means, or instructions for receiving, from the receiving device, a message indicating that the information included in the source packets may have been successfully received at the receiving device, where generating the respective sets of coded symbols includes generating sets of coded symbols within the set of multiple sets of coded symbols until the message is received.

Some examples of the method, apparatuses, and non-transitory computer-readable medium described herein may further include operations, features, means, or instructions for mapping the set of multiple sets of coded symbols to respective sets of resource elements, where the set of multiple sets of coded symbols may be transmitted based on the mapping.

In some examples of the method, apparatuses, and non-transitory computer-readable medium described herein, the rateless code may be a fountain code.

A method for wireless communication at a receiving device is described. The method may include receiving, from a transmitting device, sets of coded symbols, each of the sets of coded symbols generated based on one or more corresponding sets of binary symbols, generating, for each of the sets of coded symbols, the one or more sets of binary symbols corresponding to the set of coded symbols to obtain a set of multiple sets of binary symbols, decoding sets of binary symbols within the set of multiple sets of binary symbols to obtain encoded packets, determining that a quantity of the encoded packets exceeds a threshold based at least on the generating, and decoding the encoded packets to obtain corresponding source packets including information for the receiving device, the decoding based on the quantity of the encoded packets exceeding the threshold.

An apparatus for wireless communication at a receiving device is described. The apparatus may include a processor, memory in electronic communication with the processor, and instructions stored in the memory. The instructions may be executable by the processor to cause the apparatus to receive, from a transmitting device, sets of coded symbols, each of the sets of coded symbols generated based on one or more corresponding sets of binary symbols, generate, for each of the sets of code symbols, the one or more sets of binary symbols corresponding to the set of coded symbols to obtain a set of multiple sets of binary symbols, decode sets of binary symbols within the set of multiple sets of binary symbols to obtain encoded packets, determine that a quantity of the encoded packets exceeds a threshold based at least on the generating, and decode the encoded packets to obtain corresponding source packets including information for the receiving device, the decoding based on the quantity of the encoded packets exceeding the threshold.

Another apparatus for wireless communication at a receiving device is described. The apparatus may include means for receiving, from a transmitting device, sets of coded symbols, each of the sets of coded symbols generated based on one or more corresponding sets of binary symbols, means for generating, for each of the sets of coded symbols, the one or more sets of binary symbols corresponding to the set of coded symbols to obtain a set of multiple sets of binary symbols, means for decoding sets of binary symbols within the set of multiple sets of binary symbols to obtain encoded packets, means for determining that a quantity of the encoded packets exceeds a threshold based at least on the generating, and means for decoding the encoded packets to obtain corresponding source packets including information for the receiving device, the decoding based on the quantity of the encoded packets exceeding the threshold.

A non-transitory computer-readable medium storing code for wireless communication at a receiving device is described. The code may include instructions executable by a processor to receive, from a transmitting device, sets of coded symbols, each of the sets of coded symbols generated based on one or more corresponding sets of binary symbols, generate, for each of the sets of code symbols, the one or more sets of binary symbols corresponding to the set of coded symbols to obtain a set of multiple sets of binary symbols, decode sets of binary symbols within the set of multiple sets of binary symbols to obtain encoded packets, determine that a quantity of the encoded packets exceeds a threshold based at least on the generating, and decode the encoded packets to obtain corresponding source packets including information for the receiving device, the decoding based on the quantity of the encoded packets exceeding the threshold.

Some examples of the method, apparatuses, and non-transitory computer-readable medium described herein may further include operations, features, means, or instructions for checking for errors associated with the set of multiple sets of binary symbols, where the encoded packets each correspond to a respective decoded set of binary symbols that may be identified as error-free based on the checking.

In some examples of the method, apparatuses, and non-transitory computer-readable medium described herein, operations, features, means, or instructions for generating the one or more sets of binary symbols for a set of coded symbols included in the sets of coded symbols may include operations, features, means, or instructions for demodulating the set of coded symbols based on a layered modulation constellation.

Some examples of the method, apparatuses, and non-transitory computer-readable medium described herein may further include operations, features, means, or instructions for transmitting, to the transmitting device, a message indicating that the information included in the corresponding source packets may have been successfully received at the receiving device.

In some examples of the method, apparatuses, and non-transitory computer-readable medium described herein, a quantity of sets of binary symbols generated from a set of coded symbols included in the sets of coded symbols may be based on a quality of a channel between the transmitting device and the receiving device.

Some examples of the method, apparatuses, and non-transitory computer-readable medium described herein may further include operations, features, means, or instructions for receiving, from the transmitting device, an indication of a quantity of sets of binary symbols used to generate a set of coded symbols included in the sets of coded symbols.

### BRIEF DESCRIPTION OF THE DRAWINGS

FIG. 1 illustrates an example of a wireless communications system that supports wireless communications based on rateless codes and layered modulation in accordance with aspects of the present disclosure.

FIG. 2 illustrates an example of a wireless communications subsystem that supports wireless communications based on rateless codes and layered modulation in accordance with aspects of the present disclosure.

FIG. 3A illustrates an example of a packet generation process that supports wireless communications based on rateless codes and layered modulation in accordance with aspects of the present disclosure.

FIG. 3B illustrates exemplary layered constellations that supports wireless communications based on rateless codes and layered modulation in accordance with aspects of the present disclosure.

FIG. 4 illustrates an example of a process flow that supports wireless communications based on rateless codes and layered modulation in accordance with aspects of the present disclosure.

FIGS. 5 and 6 show block diagrams of devices that support wireless communications based on rateless codes and layered modulation in accordance with aspects of the present disclosure.

FIG. 7 shows a block diagram of a communications manager that supports wireless communications based on rateless codes and layered modulation in accordance with aspects of the present disclosure.

FIG. 8 shows a diagram of a system including a device that supports wireless communications based on rateless codes and layered modulation in accordance with aspects of the present disclosure.

FIGS. 9 and 10 show block diagrams of devices that support wireless communications based on rateless codes and layered modulation in accordance with aspects of the present disclosure.

FIG. 11 shows a block diagram of a communications manager that supports wireless communications based on rateless codes and layered modulation in accordance with aspects of the present disclosure.

FIG. 12 shows a diagram of a system including a device that supports wireless communications based on rateless codes and layered modulation in accordance with aspects of the present disclosure.

FIGS. 13 and 14 show flowcharts illustrating methods that support wireless communications based on rateless codes and layered modulation in accordance with aspects of the present disclosure.

### DETAILED DESCRIPTION

Wireless devices may communicate with one another using different modulation and coding techniques. In some examples, wireless devices may use rateless coding techniques that are used to encode data with an indeterminate coding rate (e.g., a coding rate that is not fixed, where any quantity of encoded packets may be generated based on any quantity of source packets). In some examples, a transmitting device may select a modulation technique (e.g., binary phase-shift keying (BPSK) and a coding technique (e.g., a rateless encoding technique) to use for transmissions to a receiving device based on channel state information (CSI) reported by the receiving device for the channel between the transmitting device and receiving device.

However, in some examples, the modulation and coding scheme (MC S) selected by the transmitting device may be sub-optimal for the channel across at least a portion of a transmission duration or transmission bandwidth for which the MCS is selected. For example, the selected MCS may not fully account for a fast-varying channel (e.g., a channel associated with bursty interference, high-doppler frequency, etc.) or a frequency-selective channel.

To improve a utilization of a fast-varying or frequency-selective channel and increase a throughput and/or reliability of communications, an enhanced MCS that is itself adaptive (e.g., is inherently adaptive) to channel conditions may be used. In some examples, a transmitting device may select an MCS that is associated with a modulation technique (e.g., BPSK modulation) and a rateless encoding technique. In some examples, the transmitting device may select the MCS based on channel information reported by a receiving device. After selecting the MCS, the transmitting device may generate multiple encoded packets based on multiple source packets. The transmitting device may then perform a layered modulation technique to obtain coded symbol packets (which may be referred to as network-coded symbol packets, v-packets, or using the symbol vᵢ). For example, the transmitting device may modulate the multiple encoded packets to generate multiple symbol packets (e.g., packets of binary symbols), each symbol packet including M symbols. The transmitting device may subsequently combine groups of symbol packets to form the coded symbol packets. Combining the groups of symbol packets may include scaling the symbols in the symbol packets and combining the scaled symbols across the symbol packets. The transmitting device may then transmit the coded symbol packets, such as by mapping each coded symbol in the coded symbol packets to an individual resource element.

A receiving device may receive all or a portion of the coded symbol packets. For each received coded symbol packets, the receiving device may attempt to reconstruct the group of symbol packets used to generate the corresponding coded symbol packet. In some examples, the receiving device may obtain relatively more symbol packets from a single coded symbol packet when channel conditions are good (e.g., when a signal-to-noise ratio (SNR) for the channel exceeds a threshold), and the receiving device may obtain relatively fewer symbol packets from a single coded symbol packet when channel conditions are poor (e.g., when an SNR for the channel is below a threshold). The receiving device may use each of the reconstructed symbol packets to generate reconstructed encoded packets that correspond to the encoded packets generated at the transmitting device. Once the receiving device generates enough (e.g., a threshold amount or quantity of) reconstructed encoded packets, the receiving device may decode the reconstructed encoded packets to obtain the source packets.

When a rateless encoding technique is used, the quantity of encoded packets reconstructed by the receiving device (rather than which particular encoded packets are reconstructed by the receiving device) may determine a capability of the receiving device to obtain the source packets, and thus the enhanced MCS techniques described herein may be inherently adaptive to changing channel conditions. For example, when channel conditions during a transmission duration are good, the receiving device may recover relatively more encoded packets per coded symbol packet. And when channel conditions during the transmission duration are poor, the receiving device may recover relatively fewer encoded packets per coded symbol packet, even if transmitter-side encoding and modulating behavior is unchanged. Thus, when layered modulation techniques as described herein are used, the effective coding rate and the minimum duration for transmitting a given set of information may vary as channel conditions fluctuate. By contrast, without layered modulation techniques as described herein, when channel conditions during a transmission duration are good, the receiving device may recover one encoded packet per transmitted symbol packet. And when channel conditions are poor, the receiving device may recover no encoded packets per transmitted set of symbol packet.

Aspects of the disclosure are initially described in the context of wireless communications systems. Aspects of the disclosure also described in the context of a packet generation process, a layered constellation, and a process flow. Aspects of the disclosure are further illustrated by and described with reference to apparatus diagrams, system diagrams, and flowcharts that relate to wireless communications based on rateless codes and layered modulation.

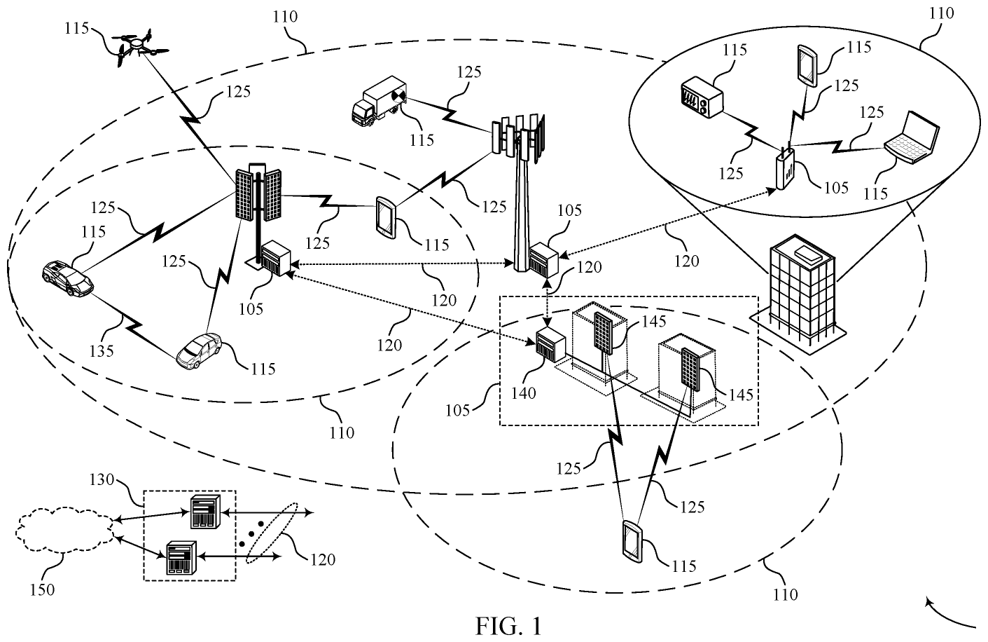

FIG. 1 illustrates an example of a wireless communications system 100 that supports wireless communications based on rateless codes and layered modulation in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or another network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or another interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the medium access control (MAC) layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

Wireless devices (e.g. base stations 105) may transmit information to other wireless device (e.g., UEs 115) using various modulation and coding techniques. Example modulation techniques include phase-shift keying and quadrature amplitude modulation. Different modulation techniques may correspond to different modulation orders (e.g., different quantities of bits represented per modulation symbol). For example, phase-shift keying may include binary phase-shift keying (BPSK), quadrature phase-shift keying (QPSK), etc. Example coding techniques include fixed rate coding techniques, such as polar coding and turbo coding, and rateless coding techniques such as fountain coding. A rateless coding technique may not fix a code rate for a transmission prior to transmitting data, while a fixed rate coding technique may fix a code rate for a transmission prior to transmitting data. That is, the ratio between data bits and overhead bits for a transmission that is encoded using a rateless code may be indeterminate. Accordingly, a size of a transmission (e.g., a quantity of packets transmitted in connection with transmitting a given set of information) using a rateless code may also be indeterminate, and a transmitter may transmit encoded packets for a set of data until the receiver receives the data or a timeout condition occurs. In some examples, rateless codes are referred to as network codes—e.g., when rateless codes are applied at the network layer. In some examples, rateless codes may be used for certain communication links in a wireless communications system 100—e.g., for an integrated access and backhaul link between base stations 105.

In some examples, a base station 105 transmits information to a UE 115 using a fountain code. Prior to transmission, the base station 105 may identify multiple source packets (which may be referred to as s-packets or using the symbol s k). Each source packet may include multiple bits of information (e.g., m bits of information), where all of the source packets together may include Nd bits of information. After identifying the source packets, the base station 105 may encode the source packets using a rateless code (e.g., a fountain code) to generate an indefinite quantity of encoded packets (which may be referred to as p-packets or using the symbol p d). In some examples, the base station 105 may generate at least as many encoded packets as source packets. In some examples, to generate the encoded packets, the base station 105 may use the following equation: pⱼ=Σₖ₌₁^{K}sₖGₖⱼ. The matrix G may be the original generator matrix used to generate a rateless code as described herein.

In some examples, to generate the encoded packets, the base station 105 may use a Luby Transform code. When using a Luby Transform code, the base station 105 may randomly choose a degree (which may be referred to using the symbol dᵢ) from a degree distribution and randomly choose dᵢ distinct source symbols with uniform distribution. The base station 105 may then apply an exclusive OR (XOR) operation to the dᵢ source symbols to obtain the encoded packets. In some examples, to generate the encoded packets, the base station 105 may use a Raptor code, which may be a combination of a low-density parity-check and a simplified Luby transform code that has a small average degree. That is, the base station 105 may generate redundant symbols during a precoding process, where each source symbol may appear three times in S redundant low density parity check (LDPC) symbols and

$$\frac{H}{2}$$

source symbols may be included in H half symbols. Also, base station 105 may randomly choose a degree dᵢ from a degree distribution and apply an XOR operation to dᵢ chosen source symbols. After encoding the source packets, the base station 105 may then begin transmitting the encoded packets to UE 115, starting with the first encoded packet.

The UE 115 may receive at least portion of the encoded packets from the base station 105. After receiving a quantity of encoded packets that exceeds a threshold (e.g., irrespective of which particular encoded packets are received), the UE 115 may recover the source packets using the following equation: rₖ=Σₙ₌₁^{N}pₙ(G′⁻¹ₙₖ). In some examples, the source packets are recoverable when the matrix G is invertible or when the rank of the matrix G′ is equal to K. In some examples, the UE 115 constructs the matrix G based on the received packets. When a Luby transform is used to generate the encoded packets, the UE 115 may perform a belief propagation decoding process to decode the received encoded packets. For example, in an encoded packet, the UE 115 may find an encoded symbol tⱼ that is connected to only one source symbol sᵢ and set sᵢ equal to tⱼ. Next, the UE 115 may apply an XOR operation to sᵢ and any encoded symbols that are connected to sᵢ. After applying the XOR operation, the UE may remove all of the connection to and from sᵢ and repeat the foregoing steps until all sᵢ are determined. If at the end, there is no encoding symbol that is connected to only one source symbol, the decoding process may fail. In some examples, instead of belief propagation decoding process, a Gaussian elimination decoding process is used.

In some examples, a transmitting device (e.g., a base station 105) may determine an MCS to use for transmitting to a receiving device (e.g., a UE 115) based on CSI (e.g., a channel quality indicator included in the CSI) reported by the receiving device. The transmitting device may use the MCS until new CSI is reported by the receiving device. For example, the transmitting device may select an MCS that is associated with BPSK modulation and rateless encoding. In such cases, the transmitting device may encode K source packets to generate an indeterminate number of encoded packets. The transmitting device may modulate the data in the encoded packets (e.g., using BPSK modulation) to generate a set of binary symbols (which may be referred to as a binary symbol packet or a b-packet) and transmit the binary symbol packets until the receiving device receives enough binary symbol packets to reconstruct the source packets. In some examples, the receiving device may reconstruct the source packets after decoding a minimum of L binary symbol packets, where a probability of error (which may be referred to as Pₑᵣᵣₒᵣ) for recovering the source packets may be determined based on the following equation:

$${P}_{error} = \{ \begin{matrix}1 , L < K \\ 0.85 \times {0.567}^{L - K} , L \geq K\end{matrix} .$$

That is, the receiving device may reconstruct the source packets after decoding K or more binary symbol packets.

However, in some examples, the MCS selected by the transmitting device may be sub-optimal for the channel across at least some portion of a corresponding transmission duration or transmission bandwidth. For example, the selected MCS may not account for a fast-varying channel (e.g., a channel associated with bursty interference, high-doppler frequency, etc.) or a frequency-selective channel. In some examples, if a transmitting device selects an MCS that is associated with BPSK modulation and rateless encoding, the transmitting device may transmit additional encoded packets to compensate for encoded packets that are lost due to bursty or frequency-selective interference, decreasing a throughput and/or reliability of communications between the transmitting device and receiving device. In other examples, a transmitting device may unnecessarily select an MCS with a lower coding rate to compensate for the bursty or frequency-selective interference, decreasing a throughput of communications between the transmitting device and receiving device to a level lower than at least some instantaneous channel conditions may support.

To improve a utilization of a fast-varying or frequency-selective channel and increase a throughput and/or reliability of communications, an enhanced MCS that is itself adaptive (e.g., is inherently adaptive) to channel conditions may be used. In some examples, a transmitting device may select an MCS that is associated with a modulation technique (e.g., BPSK modulation) and a rateless encoding technique. In some examples, the transmitting device may select the MCS based on channel information reported by a receiving device. After selecting the MCS, the transmitting device may generate multiple encoded packets based on multiple source packets. The transmitting device may then perform a layered modulation technique to obtain coded symbol packets (which may be referred to as v-packets or using the symbol vᵢ). The transmitting device may modulate the multiple encoded packets to generate multiple first symbol packets (e.g., binary symbol packets), each first symbol packet including M modulation symbols. Next, the transmitting device may combine groups of first symbol packets to form the coded symbol packets. Combining the groups of first symbol packets may include scaling the symbols in the first symbol packets (e.g., according to respective scaling factors, which may alternatively be referred to as weights) and combining the scaled symbols across the first symbol packets. The transmitting device may transmit the coded symbol packets, such as based on mapping each coded symbol in the coded symbol packets to a respective resource element. Though certain examples may describe the first symbol packets as binary symbol packets and as including binary symbols, it is to be understood that the symbols of the first symbol packets may be of any modulation order and may in some cases be non-binary.

A receiving device may receive all or a portion of the coded symbol packets. For each received coded symbol packets, the receiving device may attempt to reconstruct the group of symbol packets used to generate the corresponding coded symbol packet. In some examples, the receiving device may obtain relatively more symbol packets from a single coded symbol packet when channel conditions are good (e.g., when a signal-to-noise ratio (SNR) for the channel exceeds a threshold), and the receiving device may obtain relatively fewer symbol packets from a single coded symbol packet when channel conditions are poor (e.g., when an SNR for the channel is below a threshold). The receiving device may use each of the reconstructed symbol packets to generate reconstructed encoded packets that correspond to the encoded packets generated at the transmitting device. Once the receiving device generates enough (e.g., a threshold amount or quantity of) reconstructed encoded packets, the receiving device may decode the reconstructed encoded packets to obtain the source packets.

When a rateless encoding technique is used, the quantity of encoded packets reconstructed by the receiving device (rather than which particular encoded packets are reconstructed by the receiving device) may determine a capability of the receiving device to obtain the source packets, and thus the enhanced MCS techniques described herein may be inherently adaptive to changing channel conditions. For example, when channel conditions during a transmission duration are good, the receiving device may recover relatively more encoded packets per coded symbol packet. And when channel conditions during the transmission duration are poor, the receiving device may recover relatively fewer encoded packets per coded symbol packet, even if transmitter-side encoding and modulating behavior is unchanged. Thus, when layered modulation techniques as described herein are used, the effective coding rate and the minimum duration for transmitting a given set of information may vary as channel conditions fluctuate. By contrast, without layered modulation techniques as described herein, when channel conditions during a transmission duration are good, the receiving device may recover one encoded packet per transmitted symbol packet. And when channel conditions are poor, the receiving device may recover no encoded packets per transmitted set of symbol packet

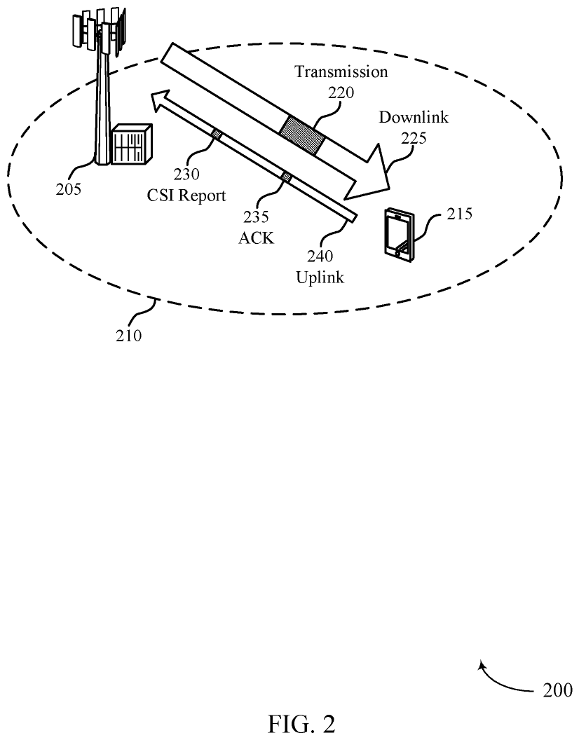

FIG. 2 illustrates an example of a wireless communications subsystem that supports wireless communications based on rateless codes and layered modulation in accordance with aspects of the present disclosure.

Wireless communications subsystem 200 may include base station 205 and UE 215, which may be respective examples of a base station and UE described in FIG. 1. Base station 205 and UE 215 may communicate within coverage area 210 using one or more of the techniques described herein and in FIG. 1.

Base station 205 may communicate with UE 215 over downlink 225 and uplink 240 over a wireless channel. In some examples, UE 215 may report information about the wireless channel to base station 205 in CSI report 230 via uplink 240. CSI report 230 may include a precoding matrix indicator, rank indicator, channel quality indicator, etc. In some examples, base station 205 selects an MCS for transmitting information to UE 215 based on the information included in the CSI report—e.g., base station 205 may select an MCS based on a channel quality indicator (CQI) included in a prior CSI report.

In some examples, base station 205 selects an MCS that is associated with a rateless coding technique (e.g., fountain coding) and a layered modulation technique for transmissions to UE 215 based on the information included in CSI report 230. In such cases, base station 205 may identify source packets that include information (e.g., user data) for UE 215, where each source packet may include m bits of information. Base station 205 may encode the source packets using a rateless code to obtain encoded packets, where each encoded packet may include m bits of information. In some examples, base station 205 may add a cyclic redundancy check (CRC) to the encoded packets to obtain error-protected packets, where each error-protected packet may include Mbits of information. Regardless of whether a CRC is added to the encoded packets, base station 205 may modulate the encoded packets (or the error-protected packets) to obtain binary symbol packets, where a quantity of symbols included in each binary symbol packet may be equal to a quantity of bits included in the corresponding encoded packet.

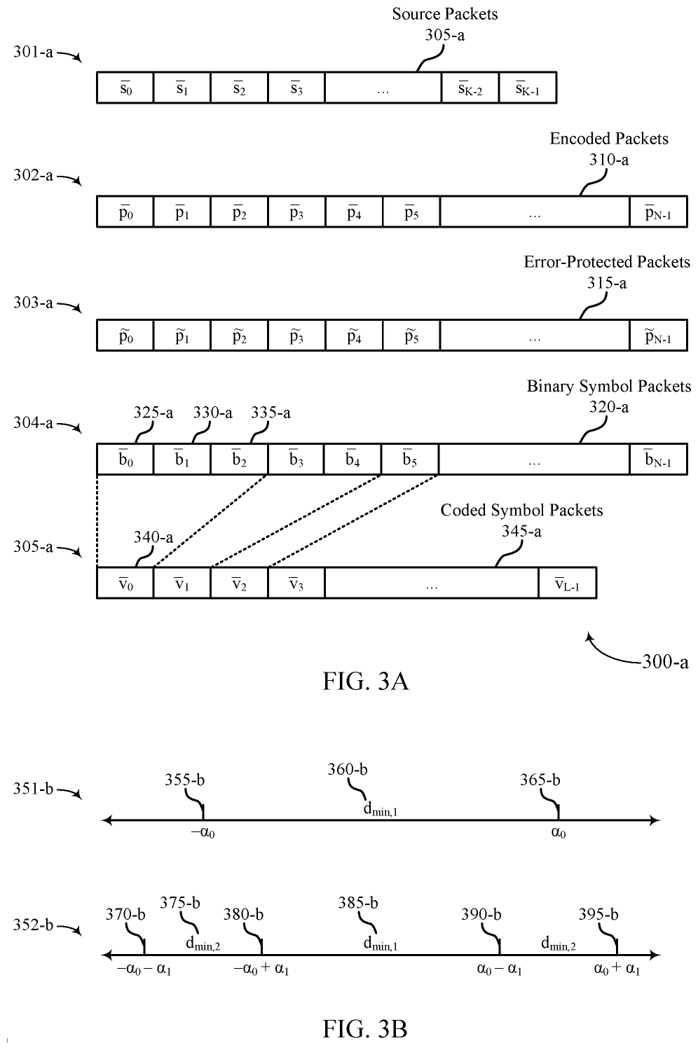

After obtaining the binary symbol packets, base station 205 may perform a layered modulation of the binary symbol packets, selecting groups (e.g., disjoint groups) of one or more binary symbol packets and generating respective coded symbol packets for each group of binary symbol packets. To generate a coded symbol packet, base station 205 may scale each of the binary symbol packets in a group of binary symbol packets and then add the scaled binary symbol packets together. The process for generating a coded symbol packet is described in more detail elsewhere herein, including with reference to FIG. 3.

Base station 205 may transmit transmission 220 to UE 215 via downlink 225. Transmission 220 may include the generated coded symbols. In some examples, transmission 220 may include enough coded symbol packets to enable UE 215 to recover enough encoded packets to reconstruct and decode the source packets. After successfully decoding the source packets, UE 215 may transmit acknowledgement message 235 to base station 205 via uplink 240. After receiving acknowledgement message 235, base station 205 may stop generating coded symbol packets for the source packets and transmission 220 may end. Base station 205 may then start generating coded symbol packets for a next set of source packets.

FIG. 3A illustrates an example of a packet generation process that supports wireless communications based on rateless codes and layered modulation in accordance with aspects of the present disclosure.

Packet generation process 300-a may illustrate one or more operations of a process for generating coded packets from a set of source packets. It is understood that one or more of the operations described in packet generation process 300 may be performed earlier or later in the process, omitted, replaced, supplemented, or performed in combination with another operation. Also, additional operations described herein that are not included in packet generation process 300-a may be included.

At 301-a, source packets 305-a may be identified and/or generated—e.g., at a transmitting device. Source packets 305-a may include information (e.g., user data or control information) for a receiving device. Each source packet may include m bits. Source packets 305-a may include K source packets.

At 302-a, encoded packets 310-a may be generated based on source packets 305-a—e.g., by the transmitting device. The transmitting device may generate an indeterminate quantity of encoded packets 310-a. For example, the transmitting device may generate encoded packets 310-a until an acknowledgment message is received from the receiving device. In some examples, the transmitting device uses a rateless code (e.g., a fountain code, a Luby transform code, a Raptor code, or a combination thereof) to generate encoded packets 310-a. In some examples, the data sequence x={p̅₀, p̅₁, p̅₂, . . . , p̅_{N-1}} is used to represent encoded packets 310-a. Each encoded packet p̅ⱼ may include m bits. Encoded packets 310-a may include N source packets, where N may be larger than K.

At 303-a, error-protected packets 315-a may be generated based on encoded packets 310-a—e.g., by the transmitting device. In some examples, error-protected packets 315-a are generated based on adding protection bits (e.g., CRC bits) to encoded packets 310-a. In some examples, the CRC bits are appended to an end of the encoded packets 310-a. In some examples, the data sequence \tilde{x}={\tilde{p}₀, \tilde{p}₁, \tilde{p}₂, . . . , \tilde{p}_{N-1}} is used to represent error-protected packets 315-a. Each error-protected packet \tilde{p}ⱼ may include M bits.

At 304-a, binary symbol packets 320-a may be generated based on error-protected packets 315-a—e.g., by the transmitting device. In some examples, binary symbol packets 320-a may be generated based on applying a BPSK modulation to the bits (e.g., each bit) in error-protected packets 315-a. In some examples, the data sequence b={b̅₀, b̅₁, b̅₂, . . . , b̅_{N-1}} is used to represent binary symbol packets 320-a. Each binary symbol packet b̅ⱼ may include M binary symbols (where each binary symbol in a binary symbol packet may be referred to as b_{j,k}). In some examples, (for example, if error protection is not added to encoded packets 310-a), binary symbol packets 320-a may be similarly generated based on encoded packets 310-a. In some examples, a different modulation technique (e.g., QPSK) may be used to generate symbol packets based on error-protected packets 315-a or encoded packets 310-a.

At 305-a, coded symbol packets 345-a may be generated based on binary symbol packets 320-a—e.g., by the transmitting device. In some examples, coded symbol packets 345-a may be generated using a layered modulation technique to obtain coded modulation symbols. In some examples, before performing the layered modulation, the transmitting device may determine a degree (which may be referred to using the symbol uᵢ) for a coded symbol packet. For instance, the transmitting device may determine a degree of three for first coded symbol packet 340-a, which may also be referred to as v̅₀. After determining the degree, the transmitting device may select a quantity (or group) of binary symbol packets 320-a that corresponds to (e.g., is equal to) the determined degree, starting with first binary symbol packet 325-a—e.g., if a degree of three is selected, then three binary symbol packets 320-a (e.g., first binary symbol packet 325-a, second binary symbol packet 330-a, and third binary symbol packet 335-a) may be selected to be modulated together in accordance with layered modulation technique.

To form a coded symbol within a coded symbol packet 345, the transmitting device may select a binary symbol from each binary symbol packet in a group of one or more binary symbol packets corresponding to the coded symbol packet 345. For example, with respect to first coded symbol packet 340-a, the transmitting device may select a binary symbol from first binary symbol packet 325-a (e.g., the first binary symbol in first binary symbol packet 325-a), a binary symbol from second binary symbol packet 330-a (e.g., the first binary symbol in second binary symbol packet 330-a), and a binary symbol from third binary symbol packet 335-a (e.g., the first binary symbol in third binary symbol packet 335-a).

The transmitting device may combine the selected binary symbols to form a coded symbol. To obtain the coded symbol, the transmitting device may use the following generalized equation:

$${\overline{v}}_{i} = {α}_{0} {\overline{b}}_{{i}_{0}} + {α}_{1} {\overline{b}}_{{i}_{1}} + … + {α}_{{u}_{i} - 1} {\overline{b}}_{{i}_{{u}_{i} - 1}} ,$$

where b̅ᵢ_{ₒ} is the first binary symbol packet 320-a used to create the coded symbol v̅ᵢ, b̅ᵢ_{₁} is the second binary symbol packet 320-a used to create the coded symbol v̅ᵢ, b̅ᵢ_{₂} is the third binary symbol packet 320-a used to create the coded symbol v̅ᵢ, and so on, and uᵢ is the degree of the coded symbol v̅ᵢ. For instance, continuing the above example for v̅₀ of FIG. 3A, b̅ᵢ_{ₒ} may correspond to the first binary symbol packet 325-a, b̅ᵢ_{₁} may correspond to the second binary symbol packet 330-a, and b̅ᵢ_{₂} may correspond to the third binary symbol packet 335-a, where v̅₀ has a degree of three. As another example, for v̅₁ of FIG. 3A, b̅ᵢ_{ₒ} may correspond to the fourth binary symbol packet (b̅₃), b̅ᵢ_{₁} may correspond to the fifth binary symbol packet (b̅₄), where v̅₁ has a degree of two. And as yet another example, for v̅₂ of FIG. 3A, b̅ᵢ_{ₒ} may correspond to the sixth binary symbol packet (b̅₅), where v̅₂ has a degree of one. In some examples, the scaling factors α₀, α₁, . . . , αᵤ_{ᵢ}₋₁ may be selected such that

$${α}_{0} \geq 2 {α}_{1} \geq 4 {α}_{2} \geq … \geq {2}^{{u}_{i} - 1} {α}_{{u}_{i} - 1} ,$$

where α₀²+α₁²+ . . . +αᵤ_{ᵢ}₋₁²≤1. In some examples, combining the selected binary symbols to obtain a coded symbol may involve mapping the binary symbols to a corresponding point in a layered constellation, as described in more detail herein and with reference to FIG. 3B.

The transmitting device may similarly combine corresponding sets of other binary symbols in the selected binary symbol packets to obtain first coded symbol packet 340-a. In some examples, the data sequence v={v̅₀, v̅₁, v̅₂, . . . , v̅_{L-1}} is used to represent coded symbol packets 345-a. Each coded symbol packet v̅ⱼ may include M symbols (where each coded symbol in a coded symbol packet may be referred to as v_{j,k}). In some examples, L may be less than or equal to N. In some examples, L may be less than or equal to K. In some examples, the same degree is used for all of binary symbol packets 320-a. In other examples, different degrees are used for different binary symbol packet in binary symbol packets 320-a. In some cases, a transmitting device may determine a degree for a binary symbol packet based on measured or predicted channel conditions. For example, if the transmitting device has identified periodic interference, the transmitting device may use a different degree (e.g., a smaller degree) than during other periods of transmitting coded symbol packets 345-a.

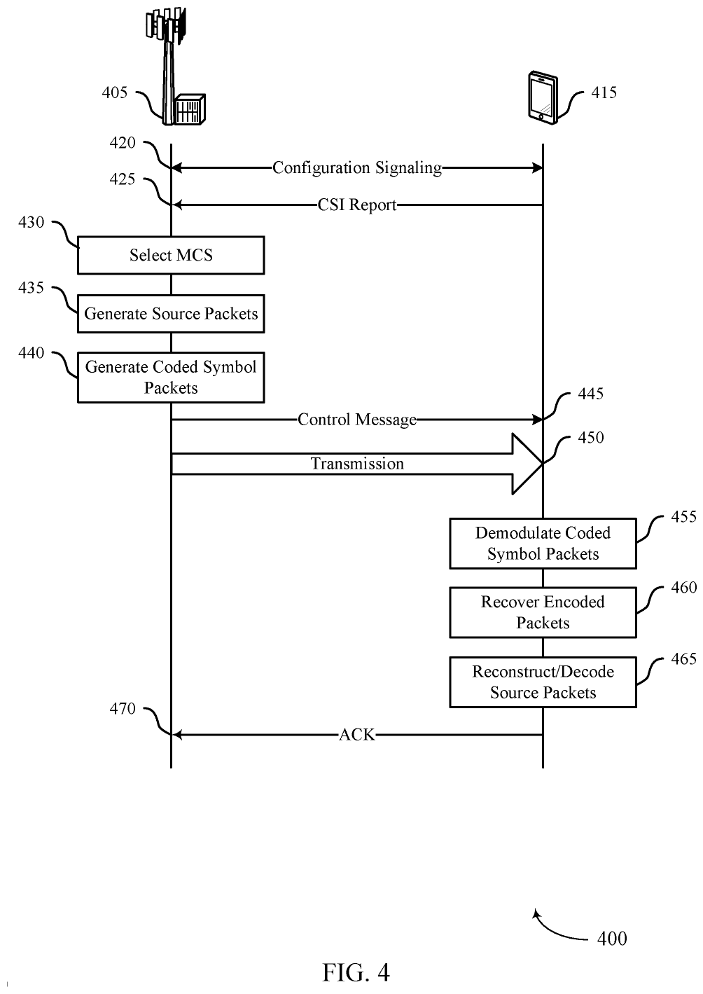

After generating a coded symbol packet, the transmitting device may map each of the coded symbols in the coded symbol packet to a resource element in a set of communication resources allocated to the receiving device. The transmitting device may then transmit the coded symbols to the receiving device over the mapped resource elements. The receiving device may receive (e.g., demodulate and decode) the coded symbols as described herein and in more detail with reference to FIG. 4.

Although FIG. 3A depicts coded symbol packets 345-a being generated from disjoint (e.g., non-overlapping) sets of binary symbol packets 320-a, in some examples, coded symbol packets 345-a may be generated from overlapping (e.g., partially or completely) sets of binary symbol packets 320-a.

FIG. 3B illustrates exemplary layered constellations that support wireless communications based on rateless codes and layered modulation in accordance with aspects of the present disclosure.

The layered constellations in FIG. 3B may depict exemplary constellations for modulating one or more symbol from one or more binary symbol packets. In some examples, the layered constellations may depict a simplified constellation, showing points only on the imaginary axis. Additionally, or alternatively, points may be similarly configured on the real axis—e.g., if a QPSK or quadrature amplitude modulation (QAM) technique is used.

First layered constellation 351-b depicts an exemplary constellation for modulating a symbol from a binary symbol packet. First layered constellation 351-b may correspond to a scenario where a degree for a layered modulation technique is set equal to 1 (e.g., uᵢ=1). In such cases, the symbols in a first binary symbol packet (e.g., first binary symbol packet 325-a) may be scaled by a first scaling factor (α₀). Thus, binary symbols corresponding to a first binary value (e.g., 0) may be mapped to first binary point 355-b, and binary symbols corresponding to a second binary value (e.g., 1) may be mapped to second binary point 365-b. Distance 360-b may correspond to a distance between the first binary point 355-b and the second binary point 365-b. In some examples, the reliability of communications may be based on a size of distance 360-b—e.g., a reliability of communications may increase as a distance between points in a constellation increases.

Second layered constellation 352-b depicts an exemplary constellation for modulating symbols from multiple binary symbol packets. Second layered constellation 352-b may correspond to a scenario where a degree for a layered modulation technique is set equal to 2 (e.g., uᵢ=2). In such cases, the symbols in a first binary symbol packet (e.g., first binary symbol packet 325-a) may be scaled by a first scaling factor (α₀) and symbols in a second binary symbol packet (e.g., second binary symbol packet 330-a) may be scaled by a second scaling factor (α₁). Thus, if a first binary symbol of a first binary symbol packet corresponds to a second binary value (e.g., 1) and a first binary symbol of a second binary symbol packet corresponds to a first binary value (e.g., 0), the combined symbol may be mapped to third point 390-b. If a first binary symbol of a first binary symbol packet corresponds to the second binary value (e.g., 1) and a first binary symbol of a second binary symbol packet corresponds to a second binary value (e.g., 1), the combined symbol may be mapped to fourth point 395-b. If a first binary symbol of a first binary symbol packet corresponds to the first binary value (e.g., 0) and a first binary symbol of a second binary symbol packet corresponds to a second binary value (e.g., 1), the combined symbol may be mapped to second point 380-b. And so on.

First distance 385-b may correspond to a distance between the second point 380-b and the third point 390-b. Second distance 375-b may correspond to a distance between the first point 370-b and the second point 380-b and a distance between the third point 390-b and the fourth point 395-b. As described herein, the reliability of communications may be based on a size of first distance 385-b and a size of second distance 375-b, where first distance 385-b may be associated with communicating symbols of the first symbol packet and second distance 375-b may be associated with communicating symbols of the second symbol packet. Thus, a receiving device may be more likely to receive the symbols of the first symbol packet than the symbols of the second symbol packet, though the receiving device may receive both (e.g., when channel conditions are good).

As described herein, the scaling factors for different binary symbol packets in a group of binary symbol packets 320-a may be selected such that α₀≥2α₁≥4α₂≥ . . . ≥2^{u}^{ᵢ}⁻¹αᵤ_{ᵢ}₋₁, where α₀²+α₁²+ . . . +αᵤ_{ᵢ}₋₁²≤1. By selecting the scaling factors using these constraints, the distances between points for the different binary symbol packets may decrease in a descending order, such that d_{min,1}≥d_{min,2}≥ . . . ≥d_{min,N}. That is, if the degree is equal to N, then the distance for a first binary symbol packet (d_{min,1}) may be represented as 2(α₁−Σᵢ₌₂^{N}αᵢ); the distance for a second binary symbol packet (d_{min,2}) may be represented as 2(a₂−Σᵢ₌₃^{N}αᵢ), and so on, where the distance for the Nth binary symbol packet (d_{min,k}) may be represented as 2(αₖ−Σᵢ₌ₖ₊₁^{N}αᵢ). Thus, the error-protection for the first binary symbol packet in a group of binary symbol packets used to generate a coded symbol packet may be higher than the error-protection for the next binary symbol packet in the group of binary symbol packets, and so on.

FIG. 4 illustrates an example of a process flow that supports wireless communications based on rateless codes and layered modulation in accordance with aspects of the present disclosure.

Process flow 400 may be performed by base station 405 and UE 415, which may be respective examples of a base station or UE described above with reference to FIGS. 1 and 2. In some examples, process flow 400 illustrates an exemplary sequence of operations performed to support communications using rateless codes and layered modulation. For example, process flow 400 depicts operations for transmitting signal that support communicating using rateless codes and layered modulation and for communicating using rateless codes and layered modulation.

It is understood that one or more of the operations described in process flow 400 may be performed earlier or later in the process, omitted, replaced, supplemented, or performed in combination with another operation. Also, additional operations described herein that are not included in process flow 400 may be included.

At arrow 420, configuration signaling may be exchanged between base station 405 and UE 415. In some examples, UE 415 may transmit an indication of support for an enhanced modulation scheme that uses rateless coding and layered modulation. In some examples, base station 405 may transmit an indication of a degree used to generate coded symbol packets from groups of binary symbol packets.

At arrow 425, UE 415 may transmit a CSI report to base station 405. The CSI report may include information about a channel between base station 405 and UE 415. The CSI report may include a CQI that indicates an SNR of reference signals received over the channel, and base station 405 may use the value of the CQI to determine an MCS to use for transmissions to UE 415. In some examples, the UE 415 may determine that the MCS associated with rateless encoding and layered modulation will be selected by base station 405 based on the value of the CQI reported in the CSI report.

At block 430, base station 405 may select an MCS based on the CSI reported from UE 415. In some examples, base station 405 selects an MCS that is associated with rateless coding and layered modulation.

At block 435, base station 405 may generate source packets based on information at base station 405 that is ready for transmission to UE 415. Each source packet may include m bits of data for UE 415.

At block 440, base station 405 may generate coded packets from the source packets. In some example, base station 405 generates the coded packets as described elsewhere herein, including with reference to FIGS. 3A and 3B.

At arrow 445, base station 405 may transmit a control message to UE 415 indicating communication resources that have been allocated to a transmission of data for UE 415 via the channel between base station 405 and UE 415. In some examples, the control message may indicate that the MCS associated with rateless encoding and layered modulation has been selected. In some examples, the control message may indicate communication resources that are scheduled to carry one or more coded symbol packets. In some examples, base station 405 may include, in the control message, an indication of a degree used for the coded symbol packets. In some examples, base station 405 may include, in the control message, an indication of a separate degree used for the different coded symbol packets.

At arrow 450, base station 405 may transmit the coded symbol packets to UE 415 via the channel between base station 405 and UE 415. In some examples, the channel is a fast-varying channel associated with bursty interference and/or a frequency selective channel associated with frequency-specific interference. In some examples, the bursty and/or frequency-specific interference corrupts a subset of the coded symbol packets transmitted to UE 415.

At block 455, UE 415 may demodulate some or all of the coded symbol packets include in the transmission from base station 405. In some examples, for a coded symbol packet, UE 415 may obtain one or more binary symbol packets used to generate the coded symbol packet. In some cases, the UE 415 may obtain all of the binary symbol packets used to generate the coded symbol packet—e.g., if the channel quality when the coded symbol packet is good. In other cases, the UE 415 may obtain a portion (e.g., one or two) of the binary symbol packets used to generate the coded symbol packet—e.g., if the channel quality when the coded symbol packet is fair. And in some examples, the UE 415 may obtain one (or none) of the binary symbol packets used to generate the coded symbol packet—e.g., if the channel quality when the coded symbol packet is poor.

To demodulate the coded symbol packets, UE 415 may refer to a layered constellation that corresponds to the degree of layered modulation used for transmitting the coded symbol packet. For example, if a degree of two was used to generate a coded symbol packet, UE 415 may refer to second layered constellation 352-b of FIG. 3B—e.g., by mapping the received coded symbols to the second layered constellation 352-b. In some examples, UE 415 may determine a first component of a coded symbol (e.g., v̅₁) that is associated with the first binary symbol packet (e.g., b̅₃) used to generate the coded symbol packet based on determining whether the mapped coded symbol is closer to the second point 380-b or third point 390-b. Next, UE 415 may determine a second component of the coded symbol that is associated with the second binary symbol packet (e.g., b̅₄) used to generate the coded symbol packet based on determining whether the mapped coded symbol is closer of first point 370-b or second point 380-b—when the coded symbol packet is closer to second point 380-b than third point 390-b. Or UE 415 may determine a second component of the coded symbol that is associated with the second binary symbol packet used to generate the coded symbol packet based on determining whether the coded symbol is closer to third point 390-b or fourth point 395-b—when the coded symbol packet is closer to third point 390-b than second point 380-b.

In some examples, the UE 415 may properly recover the first binary symbol packet used to generate in the coded symbol packet but not the second binary symbol packet. In other examples, the UE may properly recover both the first binary symbol packet and the second binary symbol packet used to generate the coded symbol packet. UE 415 may use higher-order layer constellations to similarly demodulate coded symbols that are generated using additional binary symbol packets.

At block 460, UE 415 may recover the encoded packets used to generate, at the transmitter side, the respective binary symbol packets obtained by UE 415. In some examples, to recover the encoded packets, UE 415 demodulates, for each obtained binary symbol packet, the binary symbols in the binary symbol packet to obtain a set of bits. In some examples, UE 415 may use CRC bits obtained from the binary symbol packets to perform a cyclic redundancy check for the binary symbol packet. If the cyclic redundancy check passes, UE 415 may recover the encoded packets associated with the CRC bits. In some examples, if no CRC bits are included in the binary symbol packets, the UE 415 may recover the encoded packets using the obtained bits. In some examples, UE 415 keeps track of the quantity of recovered encoded packets.

At block 465, UE 415 may use the recovered encoded packets to reconstruct the source packets originally generated at base station 405. In some examples, UE 415 uses the recovered encoded packets to reconstruct the source packets after determining that the quantity of recovered encoded packets has exceeded a threshold. If UE 415 is able to reconstruct the source packets from the recovered encoded packets—e.g., if UE 415 is able to successfully decode the source packet bits—then UE 415 may generate an acknowledgment message indicating that the source packets has been successfully decoded.

At arrow 470, UE 415 may transmit the acknowledgement message to base station 405. After receiving the acknowledgment message, base station 405 may generate a second set of source packets containing different information for UE 415. Base station 405 may similarly transmit, and UE 415 may similarly receive, the information in the second set of source packets.

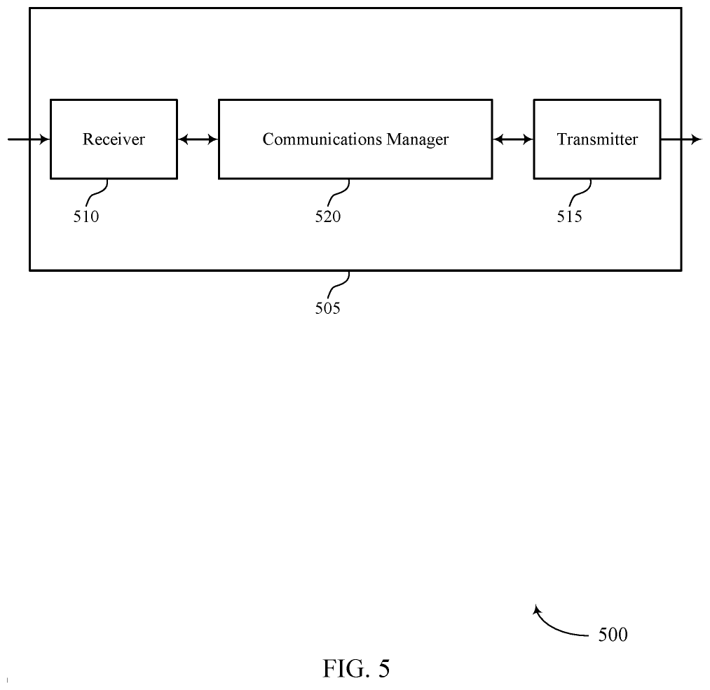

FIG. 5 shows a block diagram 500 of a device 505 that supports wireless communications based on rateless codes and layered modulation in accordance with aspects of the present disclosure. The device 505 may be an example of aspects of a base station 105 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to wireless communications based on rateless codes and layered modulation). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to wireless communications based on rateless codes and layered modulation). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of wireless communications based on rateless codes and layered modulation as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), an application-specific integrated circuit (ASIC), an field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 520 may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communication at a transmitting device in accordance with examples as disclosed herein. For example, the communications manager 520 may be configured as or otherwise support a means for generating, using a rateless code, encoded packets based on source packets including information for a receiving device. The communications manager 520 may be configured as or otherwise support a means for generating sets of binary symbols based on the encoded packets. The communications manager 520 may be configured as or otherwise support a means for selecting groups of sets of binary symbols, each of the groups including one or more of the sets of binary symbols. The communications manager 520 may be configured as or otherwise support a means for generating a respective set of coded symbols for each of the groups, the respective set of coded symbols for a group based on the one or more sets of binary symbols included in the group. The communications manager 520 may be configured as or otherwise support a means for transmitting, to the receiving device, multiple sets of coded symbols based on generating the respective sets of coded symbols (e.g., based on the generated respective sets of coded symbols).

By including or configuring the communications manager 520 in accordance with examples as described herein, the device 505 (e.g., a processor controlling or otherwise coupled to the receiver 510, the transmitter 515, the communications manager 520, or a combination thereof) may support techniques for increasing a throughput, reliability, or both of a wireless communications system—e.g., by using rateless coding and layered modulation.

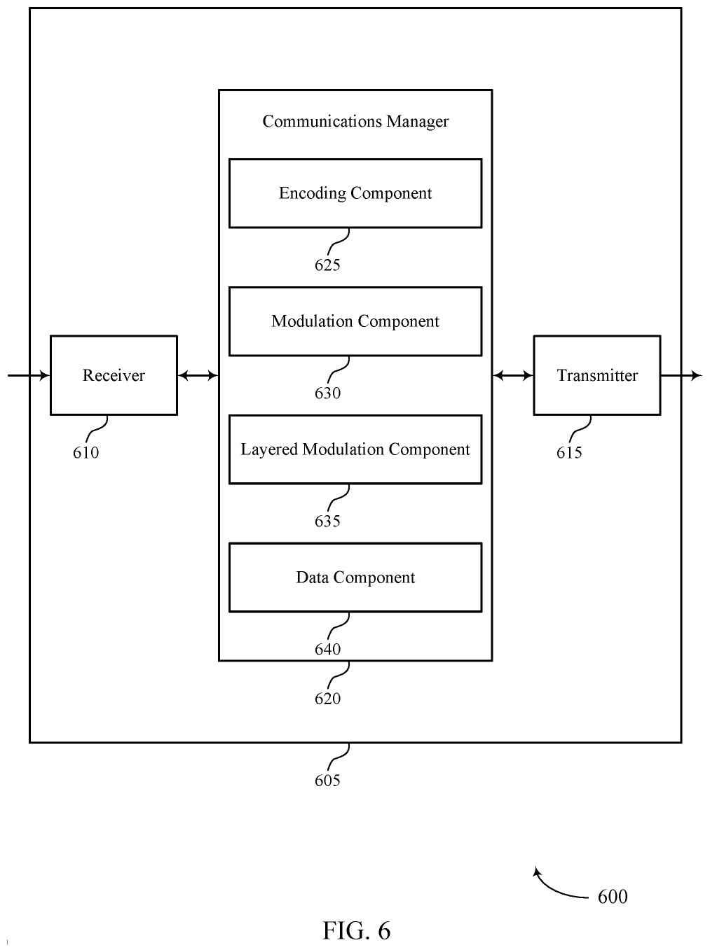

FIG. 6 shows a block diagram 600 of a device 605 that supports wireless communications based on rateless codes and layered modulation in accordance with aspects of the present disclosure. The device 605 may be an example of aspects of a device 505 or a base station 105 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to wireless communications based on rateless codes and layered modulation). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to wireless communications based on rateless codes and layered modulation). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of wireless communications based on rateless codes and layered modulation as described herein. For example, the communications manager 620 may include an encoding component 625, a modulation component 630, a layered modulation component 635, a data component 640, or any combination thereof. The communications manager 620 may be an example of aspects of a communications manager 520 as described herein. In some examples, the communications manager 620, or various components thereof, may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communication at a transmitting device in accordance with examples as disclosed herein. The encoding component 625 may be configured as or otherwise support a means for generating, using a rateless code, encoded packets based on source packets including information for a receiving device. The modulation component 630 may be configured as or otherwise support a means for generating sets of binary symbols based on the encoded packets. The layered modulation component 635 may be configured as or otherwise support a means for selecting groups of sets of binary symbols, each of the groups including one or more of the sets of binary symbols. The layered modulation component 635 may be configured as or otherwise support a means for generating a respective set of coded symbols for each of the groups, the respective set of coded symbols for a group based on the one or more sets of binary symbols included in the group. The data component 640 may be configured as or otherwise support a means for transmitting, to the receiving device, multiple sets of coded symbols based on generating the respective sets of coded symbols (e.g., based on the generated respective sets of coded symbols).

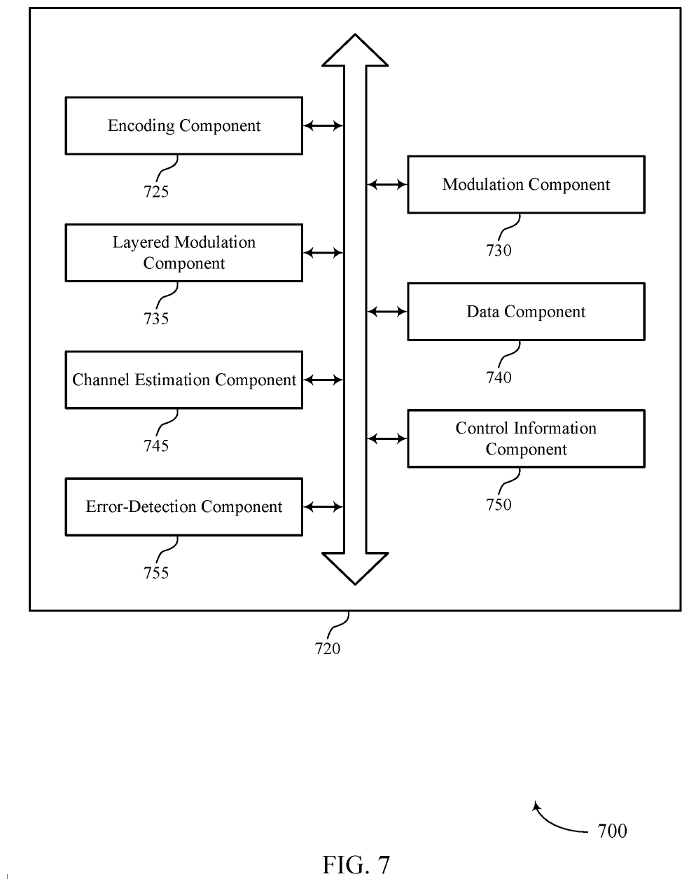

FIG. 7 shows a block diagram 700 of a communications manager 720 that supports wireless communications based on rateless codes and layered modulation in accordance with aspects of the present disclosure. The communications manager 720 may be an example of aspects of a communications manager 520, a communications manager 620, or both, as described herein. The communications manager 720, or various components thereof, may be an example of means for performing various aspects of wireless communications based on rateless codes and layered modulation as described herein. For example, the communications manager 720 may include an encoding component 725, a modulation component 730, a layered modulation component 735, a data component 740, a channel estimation component 745, a control information component 750, an error-detection component 755, or any combination thereof. Each of these components may communicate, directly or indirectly, with one another (e.g., via one or more buses).

The communications manager 720 may support wireless communication at a transmitting device in accordance with examples as disclosed herein. The encoding component 725 may be configured as or otherwise support a means for generating, using a rateless code, encoded packets based on source packets including information for a receiving device. The modulation component 730 may be configured as or otherwise support a means for generating sets of binary symbols based on the encoded packets. The layered modulation component 735 may be configured as or otherwise support a means for selecting groups of sets of binary symbols, each of the groups including one or more of the sets of binary symbols. In some examples, the layered modulation component 735 may be configured as or otherwise support a means for generating a respective set of coded symbols for each of the groups, the respective set of coded symbols for a group based on the one or more sets of binary symbols included in the group. The data component 740 may be configured as or otherwise support a means for transmitting, to the receiving device, multiple sets of coded symbols based on generating the respective sets of coded symbols (e.g., based on the generated respective sets of coded symbols).

In some examples, the data component 740 may be configured as or otherwise support a means for generating the source packets based on the information for the receiving device, where each of the source packets and each of the encoded packets includes a first quantity of bits.

In some examples, the error-detection component 755 may be configured as or otherwise support a means for adding, to each of the encoded packets, an error-detecting code to obtain second encoded packets, each of the second encoded packets including a second quantity of bits greater than the first quantity of bits.

In some examples, to support generating the sets of binary symbols, the error-detection component 755 may be configured as or otherwise support a means for generating a respective set of binary symbols for each of the second encoded packets, the respective set of binary symbols for a second encoded packet based on modulating each bit included in the second encoded packet in accordance with a first modulation order.

In some examples, generating the respective set of coded symbols for a group of sets of binary symbols includes mapping the one or more sets of binary symbols included in the group to coded symbols included in the respective set of coded symbols, the mapping based on a layered modulation constellation.

In some examples, to support generating the respective set of coded symbols for a group of sets of binary symbols, the layered modulation component 735 may be configured as or otherwise support a means for identifying multiple sets of binary symbols included in the group of sets of binary symbols. In some examples, to support generating the respective set of coded symbols for a group of sets of binary symbols, the layered modulation component 735 may be configured as or otherwise support a means for combining, across the multiple sets of binary symbols included in the group, corresponding binary symbols to obtain the respective set of coded symbols.

In some examples, to support combining the corresponding binary symbols, the layered modulation component 735 may be configured as or otherwise support a means for identifying, for each set of binary symbols included in the multiple sets of binary symbols, a respective value for scaling the binary symbols included in the set of binary symbols. In some examples, to support combining the corresponding binary symbols, the layered modulation component 735 may be configured as or otherwise support a means for multiplying, for each set of binary symbols included in the multiple sets of binary symbols, the binary symbols included in the set of binary symbols by the respective value for the set of binary symbols to obtain multiple sets of scaled binary symbols. In some examples, to support combining the corresponding binary symbols, the layered modulation component 735 may be configured as or otherwise support a means for summing, across the multiple sets of scaled binary symbols, the scaled binary symbols having a common binary symbol position.

In some examples, each of the multiple sets of binary symbols has a respective position within the multiple sets of binary symbols. In some examples, the respective values for the multiple sets of binary symbols change across the multiple sets of binary symbols in a descending order.

In some examples, each respective position within the multiple sets of binary symbols corresponds to a respective index. In some examples, the respective value for scaling a set of binary symbols having an intermediate position within the multiple sets of binary symbols is less than or equal to a first quantity, the first quantity based on multiplying a first quotient by the respective value for scaling a first set of binary symbols, the first set of binary symbols having a first position that proceeds the intermediate position, and the first quotient obtained by dividing two raised to the index of the first position by two raised to the index of the intermediary position, and greater than or equal to a second quantity, the second quantity based on multiplying a second quotient by the respective value for scaling a second set of binary symbols, the second set of binary symbols having a second position that is subsequent to the intermediate position, and the second quotient obtained by dividing two raised to the index of the second position by two raised to the index of the intermediary position.

In some examples, a result of summing the square of each of the respective values is less than or equal to one.

In some examples, the channel estimation component 745 may be configured as or otherwise support a means for estimating a channel between the transmitting device and the receiving device, where a quantity of sets of binary symbols included in at least one of the groups of sets of binary symbols is selected based on a quality of the channel.

In some examples, the control information component 750 may be configured as or otherwise support a means for transmitting, to the receiving device, an indication of a quantity of sets of binary symbols included in at least one of the groups of sets of binary symbols.

In some examples, the groups of sets of binary symbols are disjoint.

In some examples, the data component 740 may be configured as or otherwise support a means for receiving, from the receiving device, a message indicating that the information included in the source packets has been successfully received at the receiving device, where generating the respective sets of coded symbols includes generating sets of coded symbols within the set of multiple sets of coded symbols until the message is received.

In some examples, the data component 740 may be configured as or otherwise support a means for mapping the set of multiple sets of coded symbols to respective sets of resource elements, where the set of multiple sets of coded symbols are transmitted based on the mapping.

In some examples, the rateless code is a fountain code.

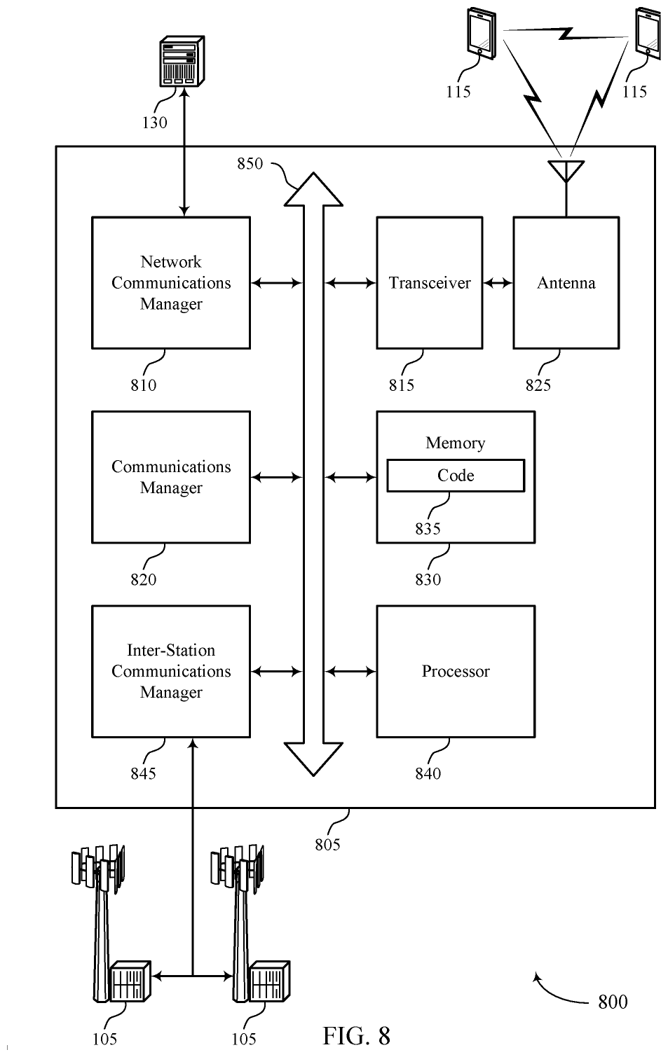

FIG. 8 shows a diagram of a system 800 including a device 805 that supports wireless communications based on rateless codes and layered modulation in accordance with aspects of the present disclosure. The device 805 may be an example of or include the components of a device 505, a device 605, or a base station 105 as described herein. The device 805 may communicate wirelessly with one or more base stations 105, UEs 115, or any combination thereof. The device 805 may include components for bi-directional voice and data communications including components for transmitting and receiving communications, such as a communications manager 820, a network communications manager 810, a transceiver 815, an antenna 825, a memory 830, code 835, a processor 840, and an inter-station communications manager 845. These components may be in electronic communication or otherwise coupled (e.g., operatively, communicatively, functionally, electronically, electrically) via one or more buses (e.g., a bus 850).

The network communications manager 810 may manage communications with a core network 130 (e.g., via one or more wired backhaul links). For example, the network communications manager 810 may manage the transfer of data communications for client devices, such as one or more UEs 115.

In some cases, the device 805 may include a single antenna 825. However, in some other cases the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random-access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting wireless communications based on rateless codes and layered modulation). For example, the device 805 or a component of the device 805 may include a processor 840 and memory 830 coupled to the processor 840, the processor 840 and memory 830 configured to perform various functions described herein.

The inter-station communications manager 845 may manage communications with other base stations 105, and may include a controller or scheduler for controlling communications with UEs 115 in cooperation with other base stations 105. For example, the inter-station communications manager 845 may coordinate scheduling for transmissions to UEs 115 for various interference mitigation techniques such as beamforming or joint transmission. In some examples, the inter-station communications manager 845 may provide an X2 interface within an LTE/LTE-A wireless communications network technology to provide communication between base stations 105.

The communications manager 820 may support wireless communication at a transmitting device in accordance with examples as disclosed herein. For example, the communications manager 820 may be configured as or otherwise support a means for generating, using a rateless code, encoded packets based on source packets including information for a receiving device. The communications manager 820 may be configured as or otherwise support a means for generating sets of binary symbols based on the encoded packets. The communications manager 820 may be configured as or otherwise support a means for selecting groups of sets of binary symbols, each of the groups including one or more of the sets of binary symbols. The communications manager 820 may be configured as or otherwise support a means for generating a respective set of coded symbols for each of the groups, the respective set of coded symbols for a group based on the one or more sets of binary symbols included in the group. The communications manager 820 may be configured as or otherwise support a means for transmitting, to the receiving device, multiple sets of coded symbols based on generating the respective sets of coded symbols (e.g., based on the generated respective sets of coded symbols).

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of wireless communications based on rateless codes and layered modulation as described herein, or the processor 840 and the memory 830 may be otherwise configured to perform or support such operations.

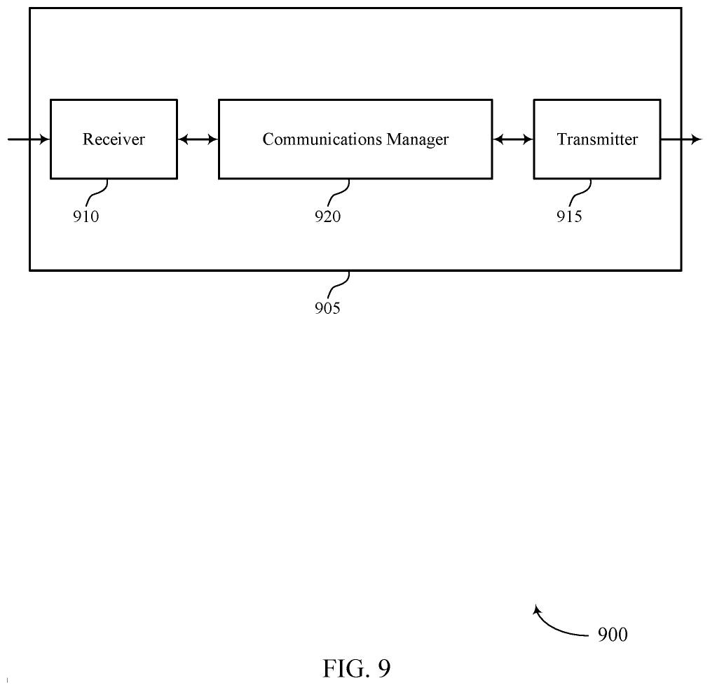

FIG. 9 shows a block diagram 900 of a device 905 that supports wireless communications based on rateless codes and layered modulation in accordance with aspects of the present disclosure. The device 905 may be an example of aspects of a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to wireless communications based on rateless codes and layered modulation). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to wireless communications based on rateless codes and layered modulation). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of wireless communications based on rateless codes and layered modulation as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 920 may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communication at a receiving device in accordance with examples as disclosed herein. For example, the communications manager 920 may be configured as or otherwise support a means for receiving, from a transmitting device, sets of coded symbols, each of the sets of coded symbols generated based on one or more corresponding sets of binary symbols. The communications manager 920 may be configured as or otherwise support a means for generating, for each of the sets of coding symbols, the one or more sets of binary symbols corresponding to the set of coded symbols to obtain a set of multiple sets of binary symbols. The communications manager 920 may be configured as or otherwise support a means for decoding sets of binary symbols within the set of multiple sets of binary symbols to obtain encoded packets. The communications manager 920 may be configured as or otherwise support a means for determining that a quantity of the encoded packets exceeds a threshold based at least on the generating. The communications manager 920 may be configured as or otherwise support a means for decoding the encoded packets to obtain corresponding source packets including information for the receiving device, the decoding based on the quantity of the encoded packets exceeding the threshold.

By including or configuring the communications manager 920 in accordance with examples as described herein, the device 905 (e.g., a processor controlling or otherwise coupled to the receiver 910, the transmitter 915, the communications manager 920, or a combination thereof) may support techniques for may support techniques for increasing a throughput and/or reliability of a wireless communications system—e.g., by using rateless coding and layered modulation.

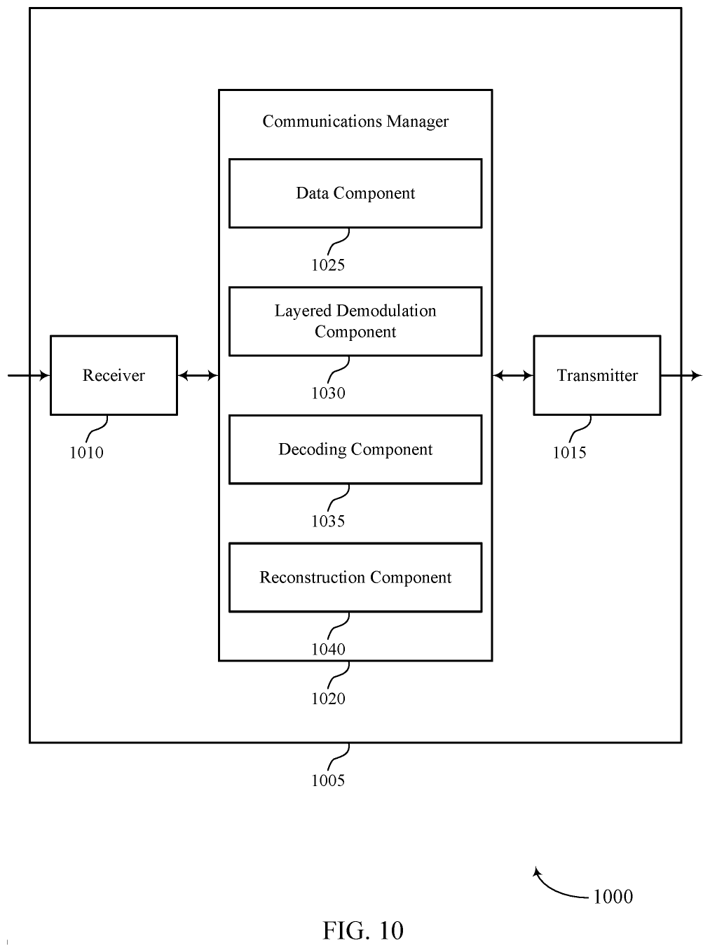

FIG. 10 shows a block diagram 1000 of a device 1005 that supports wireless communications based on rateless codes and layered modulation in accordance with aspects of the present disclosure. The device 1005 may be an example of aspects of a device 905 or a UE 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to wireless communications based on rateless codes and layered modulation). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to wireless communications based on rateless codes and layered modulation). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of wireless communications based on rateless codes and layered modulation as described herein. For example, the communications manager 1020 may include a data component 1025, a layered demodulation component 1030, a decoding component 1035, a reconstruction component 1040, or any combination thereof. The communications manager 1020 may be an example of aspects of a communications manager 920 as described herein. In some examples, the communications manager 1020, or various components thereof, may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communication at a receiving device in accordance with examples as disclosed herein. The data component 1025 may be configured as or otherwise support a means for receiving, from a transmitting device, sets of coded symbols, each of the sets of coded symbols generated based on one or more corresponding sets of binary symbols. The layered demodulation component 1030 may be configured as or otherwise support a means for generating, for each of the sets of coded symbols, the one or more sets of binary symbols corresponding to the set of coded symbols to obtain a set of multiple sets of binary symbols. The decoding component 1035 may be configured as or otherwise support a means for decoding sets of binary symbols within the set of multiple sets of binary symbols to obtain encoded packets. The reconstruction component 1040 may be configured as or otherwise support a means for determining that a quantity of the encoded packets exceeds a threshold based at least on the generating. The decoding component 1035 may be configured as or otherwise support a means for decoding the encoded packets to obtain corresponding source packets including information for the receiving device, the decoding based on the quantity of the encoded packets exceeding the threshold.

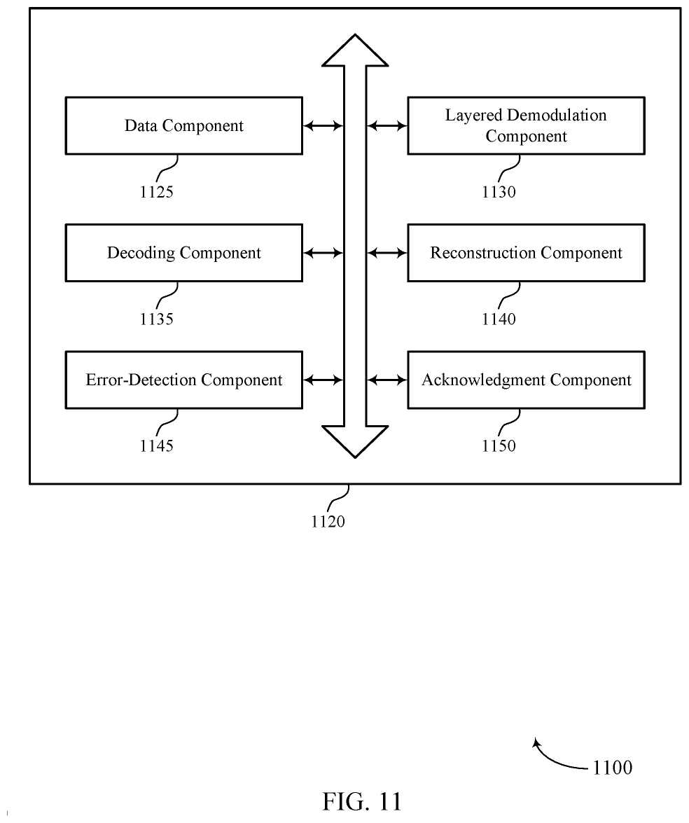

FIG. 11 shows a block diagram 1100 of a communications manager 1120 that supports wireless communications based on rateless codes and layered modulation in accordance with aspects of the present disclosure. The communications manager 1120 may be an example of aspects of a communications manager 920, a communications manager 1020, or both, as described herein. The communications manager 1120, or various components thereof, may be an example of means for performing various aspects of wireless communications based on rateless codes and layered modulation as described herein. For example, the communications manager 1120 may include a data component 1125, a layered demodulation component 1130, a decoding component 1135, a reconstruction component 1140, an error-detection component 1145, an acknowledgment component 1150, or any combination thereof. Each of these components may communicate, directly or indirectly, with one another (e.g., via one or more buses).

The communications manager 1120 may support wireless communication at a receiving device in accordance with examples as disclosed herein. The data component 1125 may be configured as or otherwise support a means for receiving, from a transmitting device, sets of coded symbols, each of the sets of coded symbols generated based on one or more corresponding sets of binary symbols. The layered demodulation component 1130 may be configured as or otherwise support a means for generating, for each of the sets of coded symbols, the one or more sets of binary symbols corresponding to the set of coded symbols to obtain a set of multiple sets of binary symbols. The decoding component 1135 may be configured as or otherwise support a means for decoding sets of binary symbols within the set of multiple sets of binary symbols to obtain encoded packets. The reconstruction component 1140 may be configured as or otherwise support a means for determining that a quantity of the encoded packets exceeds a threshold based at least on the generating. In some examples, the decoding component 1135 may be configured as or otherwise support a means for decoding the encoded packets to obtain corresponding source packets including information for the receiving device, the decoding based on the quantity of the encoded packets exceeding the threshold.

In some examples, the error-detection component 1145 may be configured as or otherwise support a means for checking for errors associated with the set of multiple sets of binary symbols, where the encoded packets each correspond to a respective decoded set of binary symbols that is identified as error-free based on the checking.

In some examples, to support generating the one or more sets of binary symbols for a set of coded symbols included in the sets of coded symbols, the layered demodulation component 1130 may be configured as or otherwise support a means for demodulating the set of coded symbols based on a layered modulation constellation.

In some examples, the acknowledgment component 1150 may be configured as or otherwise support a means for transmitting, to the transmitting device, a message indicating that the information included in the corresponding source packets has been successfully received at the receiving device.

In some examples, a quantity of sets of binary symbols generated from a set of coded symbols included in the sets of coded symbols is based on a quality of a channel between the transmitting device and the receiving device.

In some examples, the layered demodulation component 1130 may be configured as or otherwise support a means for receiving, from the transmitting device, an indication of a quantity of sets of binary symbols used to generate a set of coded symbols included in the sets of coded symbols.

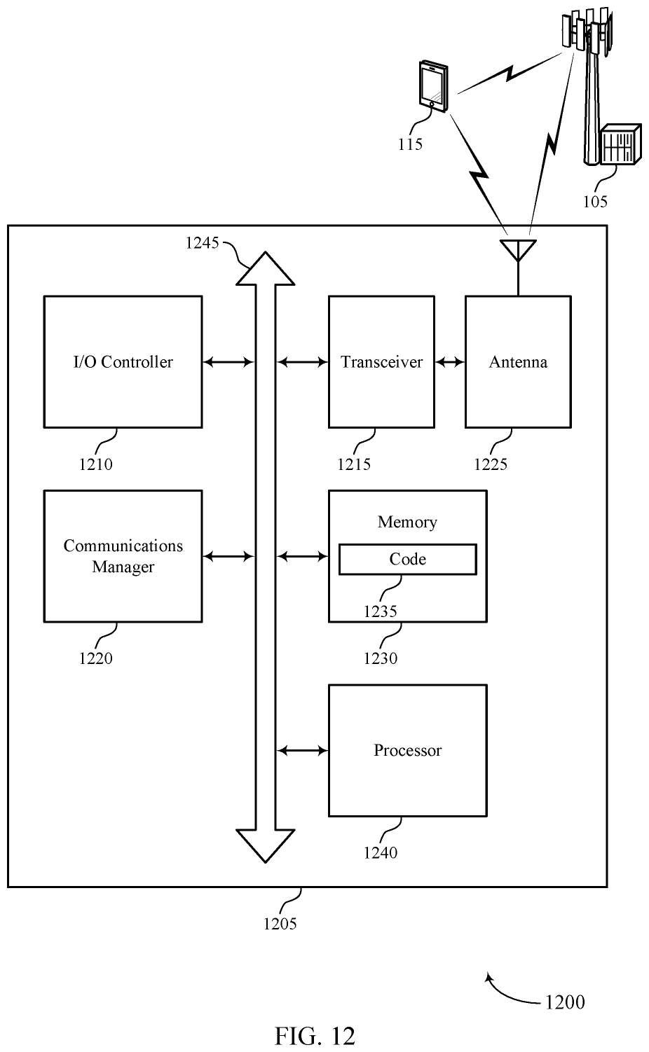

FIG. 12 shows a diagram of a system 1200 including a device 1205 that supports wireless communications based on rateless codes and layered modulation in accordance with aspects of the present disclosure. The device 1205 may be an example of or include the components of a device 905, a device 1005, or a UE 115 as described herein. The device 1205 may communicate wirelessly with one or more base stations 105, UEs 115, or any combination thereof. The device 1205 may include components for bi-directional voice and data communications including components for transmitting and receiving communications, such as a communications manager 1220, an input/output (I/O) controller 1210, a transceiver 1215, an antenna 1225, a memory 1230, code 1235, and a processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of a processor, such as the processor 1240. In some cases, a user may interact with the device 1205 via the I/O controller 1210 or via hardware components controlled by the I/O controller 1210.

In some cases, the device 1205 may include a single antenna 1225. However, in some other cases, the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include RAM and ROM. The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a BIOS which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting wireless communications based on rateless codes and layered modulation). For example, the device 1205 or a component of the device 1205 may include a processor 1240 and memory 1230 coupled to the processor 1240, the processor 1240 and memory 1230 configured to perform various functions described herein.

The communications manager 1220 may support wireless communication at a receiving device in accordance with examples as disclosed herein. For example, the communications manager 1220 may be configured as or otherwise support a means for receiving, from a transmitting device, sets of coded symbols, each of the sets of coded symbols generated based on one or more corresponding sets of binary symbols. The communications manager 1220 may be configured as or otherwise support a means for generating, for each of the sets of coding symbols, the one or more sets of binary symbols corresponding to the set of coded symbols to obtain a set of multiple sets of binary symbols. The communications manager 1220 may be configured as or otherwise support a means for decoding sets of binary symbols within the set of multiple sets of binary symbols to obtain encoded packets. The communications manager 1220 may be configured as or otherwise support a means for determining that a quantity of the encoded packets exceeds a threshold based at least on the generating. The communications manager 1220 may be configured as or otherwise support a means for decoding the encoded packets to obtain corresponding source packets including information for the receiving device, the decoding based on the quantity of the encoded packets exceeding the threshold.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of wireless communications based on rateless codes and layered modulation as described herein, or the processor 1240 and the memory 1230 may be otherwise configured to perform or support such operations.

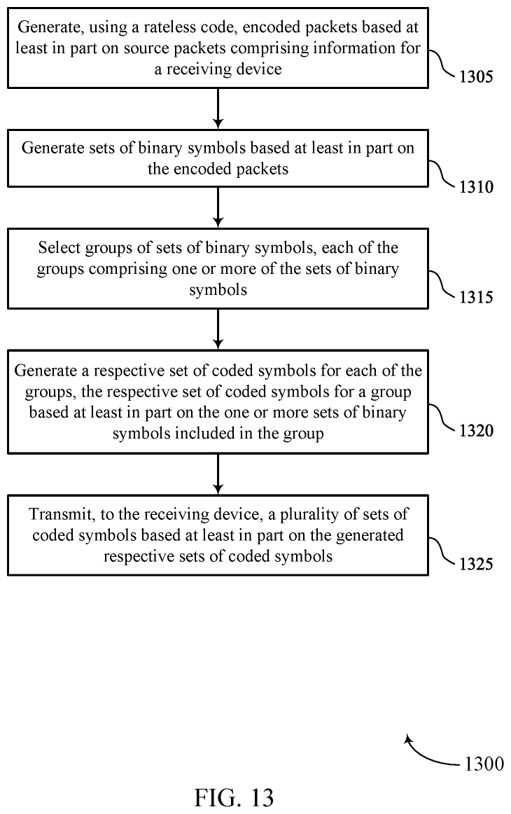

FIG. 13 shows a flowchart illustrating a method 1300 that supports wireless communications based on rateless codes and layered modulation in accordance with aspects of the present disclosure. The operations of the method 1300 may be implemented by a base station or its components as described herein. For example, the operations of the method 1300 may be performed by a base station 105 as described with reference to FIGS. 1 through 8. In some examples, a base station may execute a set of instructions to control the functional elements of the base station to perform the described functions. Additionally, or alternatively, the base station may perform aspects of the described functions using special-purpose hardware.

At 1305, the method may include generating, using a rateless code, encoded packets based on source packets including information for a receiving device. The operations of 1305 may be performed in accordance with examples as disclosed herein. In some examples, aspects of the operations of 1305 may be performed by an encoding component 725 as described with reference to FIG. 7. Additionally, or alternatively, means for performing 1305 may, but not necessarily, include, for example, antenna 825, transceiver 815, communications manager 820, memory 830 (including code 835), processor 840 and/or bus 850.

At 1310, the method may include generating sets of binary symbols based on the encoded packets. The operations of 1310 may be performed in accordance with examples as disclosed herein. In some examples, aspects of the operations of 1310 may be performed by a modulation component 730 as described with reference to FIG. 7. Additionally, or alternatively, means for performing 1310 may, but not necessarily, include, for example, antenna 825, transceiver 815, communications manager 820, memory 830 (including code 835), processor 840 and/or bus 850.

At 1315, the method may include selecting groups of sets of binary symbols, each of the groups including one or more of the sets of binary symbols. The operations of 1315 may be performed in accordance with examples as disclosed herein. In some examples, aspects of the operations of 1315 may be performed by a layered modulation component 735 as described with reference to FIG. 7. Additionally, or alternatively, means for performing 1315 may, but not necessarily, include, for example, antenna 825, transceiver 815, communications manager 820, memory 830 (including code 835), processor 840 and/or bus 850.

At 1320, the method may include generating a respective set of coded symbols for each of the groups, the respective set of coded symbols for a group based on the one or more sets of binary symbols included in the group. The operations of 1320 may be performed in accordance with examples as disclosed herein. In some examples, aspects of the operations of 1320 may be performed by a layered modulation component 735 as described with reference to FIG. 7. Additionally, or alternatively, means for performing 1320 may, but not necessarily, include, for example, antenna 825, transceiver 815, communications manager 820, memory 830 (including code 835), processor 840 and/or bus 850.

At 1325, the method may include transmitting, to the receiving device, multiple sets of coded symbols based on generating the respective sets of coded symbols (e.g., based on the generated respective sets of coded symbols). The operations of 1325 may be performed in accordance with examples as disclosed herein. In some examples, aspects of the operations of 1325 may be performed by a data component 740 as described with reference to FIG. 7. Additionally, or alternatively, means for performing 1325 may, but not necessarily, include, for example, antenna 825, transceiver 815, communications manager 820, memory 830 (including code 835), processor 840 and/or bus 850.

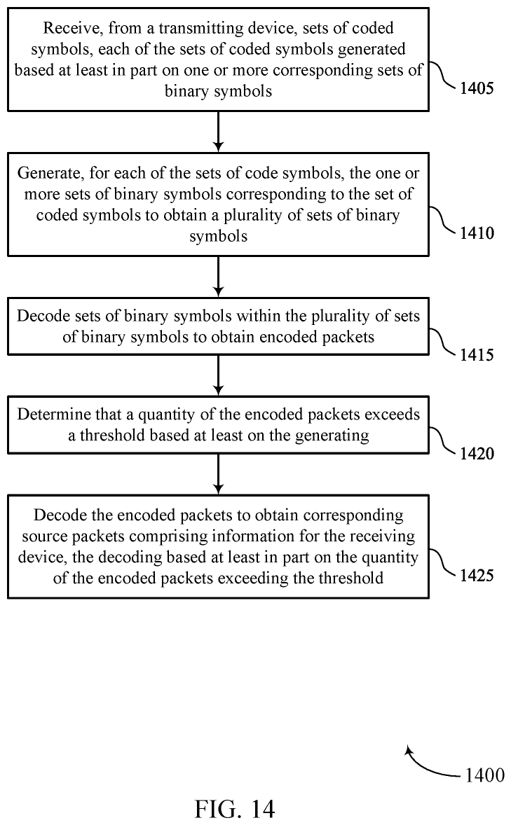

FIG. 14 shows a flowchart illustrating a method 1400 that supports wireless communications based on rateless codes and layered modulation in accordance with aspects of the present disclosure. The operations of the method 1400 may be implemented by a UE or its components as described herein. For example, the operations of the method 1400 may be performed by a UE 115 as described with reference to FIGS. 1 through 4 and 9 through 12. In some examples, a UE may execute a set of instructions to control the functional elements of the UE to perform the described functions. Additionally, or alternatively, the UE may perform aspects of the described functions using special-purpose hardware.

At 1405, the method may include receiving, from a transmitting device, sets of coded symbols, each of the sets of coded symbols generated based on one or more corresponding sets of binary symbols. The operations of 1405 may be performed in accordance with examples as disclosed herein. In some examples, aspects of the operations of 1405 may be performed by a data component 1125 as described with reference to FIG. 11. Additionally, or alternatively, means for performing 1405 may, but not necessarily, include, for example, antenna 1225, transceiver 1215, communications manager 1220, memory 1230 (including code 1235), processor 1240 and/or bus 1250.

At 1410, the method may include generating, for each of the sets of coded symbols, the one or more sets of binary symbols corresponding to the set of coded symbols to obtain a set of multiple sets of binary symbols. The operations of 1410 may be performed in accordance with examples as disclosed herein. In some examples, aspects of the operations of 1410 may be performed by a layered demodulation component 1130 as described with reference to FIG. 11. Additionally, or alternatively, means for performing 1410 may, but not necessarily, include, for example, antenna 1225, transceiver 1215, communications manager 1220, memory 1230 (including code 1235), processor 1240 and/or bus 1250.

At 1415, the method may include decoding sets of binary symbols within the set of multiple sets of binary symbols to obtain encoded packets. The operations of 1415 may be performed in accordance with examples as disclosed herein. In some examples, aspects of the operations of 1415 may be performed by a decoding component 1135 as described with reference to FIG. 11. Additionally, or alternatively, means for performing 1415 may, but not necessarily, include, for example, antenna 1225, transceiver 1215, communications manager 1220, memory 1230 (including code 1235), processor 1240 and/or bus 1250.

At 1420, the method may include determining that a quantity of the encoded packets exceeds a threshold based at least on the generating. The operations of 1420 may be performed in accordance with examples as disclosed herein. In some examples, aspects of the operations of 1420 may be performed by a reconstruction component 1140 as described with reference to FIG. 11. Additionally, or alternatively, means for performing 1420 may, but not necessarily, include, for example, antenna 1225, transceiver 1215, communications manager 1220, memory 1230 (including code 1235), processor 1240 and/or bus 1250.

At 1425, the method may include decoding the encoded packets to obtain corresponding source packets including information for the receiving device, the decoding based on the quantity of the encoded packets exceeding the threshold. The operations of 1425 may be performed in accordance with examples as disclosed herein. In some examples, aspects of the operations of 1425 may be performed by a decoding component 1135 as described with reference to FIG. 11. Additionally, or alternatively, means for performing 1425 may, but not necessarily, include, for example, antenna 1225, transceiver 1215, communications manager 1220, memory 1230 (including code 1235), processor 1240 and/or bus 1250.

The following provides an overview of aspects of the present disclosure:

Aspect 1: A method for wireless communication at a transmitting device, comprising: generating, using a rateless code, encoded packets based at least in part on source packets comprising information for a receiving device; generating sets of binary symbols based at least in part on the encoded packets; selecting groups of sets of binary symbols, each of the groups comprising one or more of the sets of binary symbols; generating a respective set of coded symbols for each of the groups, the respective set of coded symbols for a group based at least in part on the one or more sets of binary symbols included in the group; and transmitting, to the receiving device, a plurality of sets of coded symbols based at least in part on the generated respective sets of coded symbols.

Aspect 2: The method of aspect 1, further comprising: generating the source packets based at least in part on the information for the receiving device, wherein each of the source packets and each of the encoded packets comprises a first quantity of bits.

Aspect 3: The method of aspect 2, further comprising: adding, to each of the encoded packets, an error-detecting code to obtain second encoded packets, each of the second encoded packets comprising a second quantity of bits greater than the first quantity of bits.

Aspect 4: The method of aspect 3, wherein generating the sets of binary symbols comprises: generating a respective set of binary symbols for each of the second encoded packets, the respective set of binary symbols for a second encoded packet based at least in part on modulating each bit included in the second encoded packet in accordance with a first modulation order.

Aspect 5: The method of any of aspects 1 through 4, wherein generating the respective set of coded symbols for a group of sets of binary symbols comprises mapping the one or more sets of binary symbols included in the group to coded symbols included in the respective set of coded symbols, the mapping based at least in part on a layered modulation constellation.

Aspect 6: The method of any of aspects 1 through 5, wherein generating the respective set of coded symbols for a group of sets of binary symbols comprises: identifying multiple sets of binary symbols included in the group of sets of binary symbols; and combining, across the multiple sets of binary symbols included in the group, corresponding binary symbols to obtain the respective set of coded symbols.

Aspect 7: The method of aspect 6, wherein each of the multiple sets of binary symbols is associated with a common set of binary symbol positions, and wherein combining the corresponding binary symbols comprises: identifying, for each set of binary symbols included in the multiple sets of binary symbols, a respective value for scaling the binary symbols included in the set of binary symbols; multiplying, for each set of binary symbols included in the multiple sets of binary symbols, the binary symbols included in the set of binary symbols by the respective value for the set of binary symbols to obtain multiple sets of scaled binary symbols; and summing, across the multiple sets of scaled binary symbols, the scaled binary symbols having a common binary symbol position.

Aspect 8: The method of aspect 7, wherein each of the multiple sets of binary symbols has a respective position within the multiple sets of binary symbols, and the respective values for the multiple sets of binary symbols change across the multiple sets of binary symbols in a descending order.

Aspect 9: The method of aspect 8, wherein each respective position within the multiple sets of binary symbols corresponds to a respective index, and the respective value for scaling a set of binary symbols having an intermediate position within the multiple sets of binary symbols is less than or equal to a first quantity, the first quantity based at least in part on multiplying a first quotient by the respective value for scaling a first set of binary symbols, the first set of binary symbols having a first position that proceeds the intermediate position, and the first quotient obtained by dividing two raised to the index of the first position by two raised to the index of the intermediary position, and greater than or equal to a second quantity, the second quantity based at least in part on multiplying a second quotient by the respective value for scaling a second set of binary symbols, the second set of binary symbols having a second position that is subsequent to the intermediate position, and the second quotient obtained by dividing two raised to the index of the second position by two raised to the index of the intermediary position.

Aspect 10: The method of any of aspects 8 through 9, wherein a result of summing the square of each of the respective values is less than or equal to one.

Aspect 11: The method of any of aspects 1 through 10, further comprising: estimating a channel between the transmitting device and the receiving device, wherein a quantity of sets of binary symbols included in at least one of the groups of sets of binary symbols is selected based at least in part on a quality of the channel.

Aspect 12: The method of any of aspects 1 through 11, further comprising: transmitting, to the receiving device, an indication of a quantity of sets of binary symbols included in at least one of the groups of sets of binary symbols.

Aspect 13: The method of any of aspects 1 through 12, wherein the groups of sets of binary symbols are disjoint.

Aspect 14: The method of any of aspects 1 through 13, further comprising: receiving, from the receiving device, a message indicating that the information included in the source packets has been successfully received at the receiving device, wherein generating the respective sets of coded symbols comprises generating sets of coded symbols within the plurality of sets of coded symbols until the message is received.

Aspect 15: The method of any of aspects 1 through 14, further comprising: mapping the plurality of sets of coded symbols to respective sets of resource elements, wherein the plurality of sets of coded symbols are transmitted based at least in part on the mapping.

Aspect 16: The method of any of aspects 1 through 15, wherein the rateless code is a fountain code.

Aspect 17: A method for wireless communication at a receiving device, comprising: receiving, from a transmitting device, sets of coded symbols, each of the sets of coded symbols generated based at least in part on one or more corresponding sets of binary symbols; generating, for each of the sets of coded symbols, the one or more sets of binary symbols corresponding to the set of coded symbols to obtain a plurality of sets of binary symbols; decoding sets of binary symbols within the plurality of sets of binary symbols to obtain encoded packets; determining that a quantity of the encoded packets exceeds a threshold based at least on the generating; and decoding the encoded packets to obtain corresponding source packets comprising information for the receiving device, the decoding based at least in part on the quantity of the encoded packets exceeding the threshold.

Aspect 18: The method of aspect 17, further comprising: checking for errors associated with the plurality of sets of binary symbols, wherein the encoded packets each correspond to a respective decoded set of binary symbols that is identified as error-free based at least in part on the checking.

Aspect 19: The method of any of aspects 17 through 18, wherein generating the one or more sets of binary symbols for a set of coded symbols included in the sets of coded symbols comprises: demodulating the set of coded symbols based at least in part on a layered modulation constellation.

Aspect 20: The method of any of aspects 17 through 19, further comprising: transmitting, to the transmitting device, a message indicating that the information included in the corresponding source packets has been successfully received at the receiving device.

Aspect 21: The method of any of aspects 17 through 20, wherein a quantity of sets of binary symbols generated from a set of coded symbols included in the sets of coded symbols is based at least in part on a quality of a channel between the transmitting device and the receiving device.

Aspect 22: The method of any of aspects 17 through 21, further comprising: receiving, from the transmitting device, an indication of a quantity of sets of binary symbols used to generate a set of coded symbols included in the sets of coded symbols.

Aspect 23: An apparatus for wireless communication at a transmitting device, comprising a processor; memory coupled with the processor; and instructions stored in the memory and executable by the processor to cause the apparatus to perform a method of any of aspects 1 through 16.

Aspect 24: An apparatus for wireless communication at a transmitting device, comprising at least one means for performing a method of any of aspects 1 through 16.

Aspect 25: A non-transitory computer-readable medium storing code for wireless communication at a transmitting device, the code comprising instructions executable by a processor to perform a method of any of aspects 1 through 16.

Aspect 26: An apparatus for wireless communication at a receiving device, comprising a processor; memory coupled with the processor; and instructions stored in the memory and executable by the processor to cause the apparatus to perform a method of any of aspects 17 through 22.

Aspect 27: An apparatus for wireless communication at a receiving device, comprising at least one means for performing a method of any of aspects 17 through 22.

Aspect 28: A non-transitory computer-readable medium storing code for wireless communication at a receiving device, the code comprising instructions executable by a processor to perform a method of any of aspects 17 through 22.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a transmitting device, comprising:
generating, using a rateless code, encoded packets based at least in part on source packets comprising information for a receiving device;
generating sets of binary symbols based at least in part on the encoded packets;
selecting groups of sets of binary symbols, each of the groups comprising one or more of the sets of binary symbols;
generating a respective set of coded symbols for each of the groups, the respective set of coded symbols for a group based at least in part on the one or more sets of binary symbols included in the group; and
transmitting, to the receiving device, a plurality of sets of coded symbols based at least in part on the generated respective sets of coded symbols.

2. The method of claim 1, further comprising:
generating the source packets based at least in part on the information for the receiving device, wherein each of the source packets and each of the encoded packets comprises a first quantity of bits.

3. The method of claim 2, further comprising:
adding, to each of the encoded packets, an error-detecting code to obtain second encoded packets, each of the second encoded packets comprising a second quantity of bits greater than the first quantity of bits.

4. The method of claim 3, wherein generating the sets of binary symbols comprises:
generating a respective set of binary symbols for each of the second encoded packets, the respective set of binary symbols for a second encoded packet based at least in part on modulating each bit included in the second encoded packet in accordance with a first modulation order.

5. The method of claim 1, wherein generating the respective set of coded symbols for a group of sets of binary symbols comprises mapping the one or more sets of binary symbols included in the group to coded symbols included in the respective set of coded symbols, the mapping based at least in part on a layered modulation constellation.

6. The method of claim 1, wherein generating the respective set of coded symbols for a group of sets of binary symbols comprises:
identifying multiple sets of binary symbols included in the group of sets of binary symbols; and
combining, across the multiple sets of binary symbols included in the group, corresponding binary symbols to obtain the respective set of coded symbols.

7. The method of claim 6, wherein each of the multiple sets of binary symbols is associated with a common set of binary symbol positions, and wherein combining the corresponding binary symbols comprises:
identifying, for each set of binary symbols included in the multiple sets of binary symbols, a respective value for scaling the binary symbols included in the set of binary symbols;
multiplying, for each set of binary symbols included in the multiple sets of binary symbols, the binary symbols included in the set of binary symbols by the respective value for the set of binary symbols to obtain multiple sets of scaled binary symbols; and
summing, across the multiple sets of scaled binary symbols, the scaled binary symbols having a common binary symbol position.

8. The method of claim 7, wherein each of the multiple sets of binary symbols has a respective position within the multiple sets of binary symbols, and wherein the respective values for the multiple sets of binary symbols change across the multiple sets of binary symbols in a descending order.

9. The method of claim 8, wherein each respective position within the multiple sets of binary symbols corresponds to a respective index, and wherein the respective value for scaling a set of binary symbols having an intermediate position within the multiple sets of binary symbols is:
less than or equal to a first quantity, the first quantity based at least in part on multiplying a first quotient by the respective value for scaling a first set of binary symbols, the first set of binary symbols having a first position that proceeds the intermediate position, and the first quotient obtained by dividing two raised to the index of the first position by two raised to the index of the intermediate position, and
greater than or equal to a second quantity, the second quantity based at least in part on multiplying a second quotient by the respective value for scaling a second set of binary symbols, the second set of binary symbols having a second position that is subsequent to the intermediate position, and the second quotient obtained by dividing two raised to the index of the second position by two raised to the index of the intermediate position.

10. The method of claim 8, wherein a result of summing the square of each of the respective values is less than or equal to one.

11. The method of claim 1, further comprising:
estimating a channel between the transmitting device and the receiving device, wherein a quantity of sets of binary symbols included in at least one of the groups of sets of binary symbols is selected based at least in part on a quality of the channel.

12. The method of claim 1, further comprising:
transmitting, to the receiving device, an indication of a quantity of sets of binary symbols included in at least one of the groups of sets of binary symbols.

13. The method of claim 1, wherein the groups of sets of binary symbols are disjoint.

14. The method of claim 1, further comprising:
receiving, from the receiving device, a message indicating that the information included in the source packets has been successfully received at the receiving device, wherein generating the respective sets of coded symbols comprises generating sets of coded symbols within the plurality of sets of coded symbols until the message is received.

15. The method of claim 1, further comprising:
mapping the plurality of sets of coded symbols to respective sets of resource elements, wherein the plurality of sets of coded symbols are transmitted based at least in part on the mapping.

16. The method of claim 1, wherein the rateless code is a fountain code.

17. A method for wireless communication at a receiving device, comprising:
receiving, from a transmitting device, sets of coded symbols, each of the sets of coded symbols generated based at least in part on one or more corresponding sets of binary symbols;
generating, for each of the sets of coded symbols, the one or more sets of binary symbols corresponding to the set of coded symbols to obtain a plurality of sets of binary symbols;
decoding sets of binary symbols within the plurality of sets of binary symbols to obtain encoded packets;
determining that a quantity of the encoded packets exceeds a threshold based at least on the generating; and
decoding the encoded packets to obtain corresponding source packets comprising information for the receiving device, the decoding based at least in part on the quantity of the encoded packets exceeding the threshold.

18. The method of claim 17, further comprising:
checking for errors associated with the plurality of sets of binary symbols, wherein the encoded packets each correspond to a respective decoded set of binary symbols that is identified as error-free based at least in part on the checking.

19. The method of claim 17, wherein generating the one or more sets of binary symbols for a set of coded symbols included in the sets of coded symbols comprises:
demodulating the set of coded symbols based at least in part on a layered modulation constellation.

20. The method of claim 17, further comprising:
transmitting, to the transmitting device, a message indicating that the information included in the corresponding source packets has been successfully received at the receiving device.

21. The method of claim 17, wherein a quantity of sets of binary symbols generated from a set of coded symbols included in the sets of coded symbols is based at least in part on a quality of a channel between the transmitting device and the receiving device.

22. The method of claim 17, further comprising:
receiving, from the transmitting device, an indication of a quantity of sets of binary symbols used to generate a set of coded symbols included in the sets of coded symbols.

23. An apparatus for wireless communication, comprising:
a processor of a transmitting device;
memory coupled with the processor, the memory and the processor configured to:
generate, using a rateless code, encoded packets based at least in part on source packets comprising information for a receiving device;
generate sets of binary symbols based at least in part on the encoded packets;
select groups of sets of binary symbols, each of the groups comprising one or more of the sets of binary symbols;
generate a respective set of coded symbols for each of the groups, the respective set of coded symbols for a group based at least in part on the one or more sets of binary symbols included in the group; and
transmit, to the receiving device, a plurality of sets of coded symbols based at least in part on the generated respective sets of coded symbols.

24. The apparatus of claim 23, the memory and the processor further configured to:
generate the source packets based at least in part on the information for the receiving device, wherein each of the source packets and each of the encoded packets comprises a first quantity of bits.

25. The apparatus of claim 24, the memory and the processor further configured to:
add, to each of the encoded packets, an error-detecting code to obtain second encoded packets, each of the second encoded packets comprising a second quantity of bits greater than the first quantity of bits.

26. The apparatus of claim 25, wherein to generate the sets of binary symbol, the memory and the processor are configured to:
generate a respective set of binary symbols for each of the second encoded packets, the respective set of binary symbols for a second encoded packet based at least in part on modulating each bit included in the second encoded packet in accordance with a first modulation order.

27. The apparatus of claim 23, wherein to generate the respective set of coded symbols for a group of sets of binary symbols, the memory and the processor are configured to:
map the one or more sets of binary symbols included in the group to coded symbols included in the respective set of coded symbols, the mapping based at least in part on a layered modulation constellation.

28. The apparatus of claim 23, wherein to generate the respective set of coded symbols for a group of sets of binary symbols, the memory and the processor are configured to:
identify multiple sets of binary symbols included in the group of sets of binary symbols; and
combine, across the multiple sets of binary symbols included in the group, corresponding binary symbols to obtain the respective set of coded symbols.

29. An apparatus for wireless communication, comprising:
a processor of a receiving device;
memory coupled with the processor, the memory and the processor configured to:
receive, from a transmitting device, sets of coded symbols, each of the sets of coded symbols generated based at least in part on one or more corresponding sets of binary symbols;
generating, for each of the sets of code symbols, the one or more sets of binary symbols corresponding to the set of coded symbols to obtain a plurality of sets of binary symbols;
decode sets of binary symbols within the plurality of sets of binary symbols to obtain encoded packets;
determine that a quantity of the encoded packets exceeds a threshold based at least on the generating; and
decode the encoded packets to obtain corresponding source packets comprising information for the receiving device, the decoding based at least in part on the quantity of the encoded packets exceeding the threshold.

30. The apparatus of claim 29, the memory and the processor further configured to:
check for errors associated with the plurality of sets of binary symbols, wherein the encoded packets each correspond to a respective decoded set of binary symbols that is identified as error-free based at least in part on the checking.
